(19) United States
(12) Patent Application Publication
(10) Pub. No.: US 2025/0055224 A1
(43) Pub. Date: Feb. 13, 2025

(54) ELECTRICAL CONNECTOR

(71) Applicant: J.S.T. Mfg. Co., Ltd., Tokyo (JP)

(72) Inventors: Satoru SHINDO, Yokohama-shi (JP); Teppei UETSUJI, Yokohama-shi (JP); Masaki TAKEDA, Yokohama-shi (JP)

(73) Assignee: J.S.T. Mfg. Co., Ltd., Tokyo (JP)

(21) Appl. No.: 18/745,373

(22) Filed: Jun. 17, 2024

(30) Foreign Application Priority Data
Aug. 8, 2023 (JP) 2023-129088

(51) Int. Cl. H01R 13/631; H01R 13/422; H01R 13/506

(52) U.S. Cl. CPC H01R 13/6315; H01R 13/4223; H01R 13/506

(57) ABSTRACT

An electrical connector includes a fixed housing, a movable housing, and a plurality of terminals. The movable housing includes a guide portion that is provided with an opening and receives a plurality of partner connection members, and a plurality of insertion holes that are arranged side by side inside the guide portion and respectively receive insertion of the partner connection members. An inner wall of the guide portion includes first inclined surfaces that are respectively provided at two end sides in the width direction and widen in a tapered manner while extending in the height direction and outward in the width direction. Second inclined surfaces, which are provided between each pair of the insertion holes adjacent to each other in the width direction, extend in a tapered manner toward the entrances of the insertion holes. The first inclined surfaces have a larger dimension in the width direction and dimension in the height direction than the second inclined surfaces.

### CROSS-REFERENCE TO RELATED APPLICATION

This application claims priority to Japanese Patent Application No. 2023-129088. The entire disclosure of Japanese Patent Application No. 2023-129088 is hereby incorporated herein by reference.

### BACKGROUND OF THE INVENTION

### 1. Field of the Invention

The present invention relates to an electrical connector to which a plurality of pin-shaped partner connection members arranged side by side are connected by being inserted into the electrical connector, the electrical connector including a fixed housing to be disposed on a substrate, a movable housing mounted so as to be displaceable relative to the fixed housing, and a plurality of terminals that support the movable housing so as to be displaceable relative to the fixed housing.

### 2. Description of Related Art

Conventionally, when a plurality of pin-shaped partner connection members arranged side by side are to be connected to a substrate, an electrical connector is disposed on the substrate, and the pin-shaped partner connection members are connected to the electrical connector by being inserted therein. Some electrical connectors such as that described above include a fixed housing to be disposed on a substrate, a movable housing mounted so as to be displaceable relative to the fixed housing, and a plurality of terminals that support the movable housing so as to be displaceable relative to the fixed housing and that are to be electrically connected to a partner connection member. Since the movable housing is supported so as to be displaceable relative to the fixed housing in such an electrical connector, positional deviation between the substrate and the partner connection member can be absorbed. For example, even if vibration occurs in the substrate while the partner connection member is connected to the substrate via the electrical connector, the vibration occurring in the substrate can be absorbed by the terminals between the substrate and the partner connection member, thus making it possible to suppress the transmission of vibration to the partner connection member. Known examples of such an electrical connector are disclosed in JP 2019-160698A and JP 2019-207747A.

The electrical connector disclosed in JP 2019-160698A includes a fixed housing 4 to be disposed on a substrate P, a movable housing 5 mounted so as to be displaceable relative to the fixed housing 4, and a plurality of terminals 3 that support the movable housing 5 to the fixed housing 4 and that are to be respectively electrically connected to a plurality of pin terminals T, which are pin-shaped partner connection members.

The electrical connector disclosed in JP 2019-207747A includes a fixed housing 31 to be disposed on a substrate 24b, a movable housing 32 mounted so as to be displaceable relative to the fixed housing 31, and a plurality of connector terminals 33 that support the movable housing 32 to the fixed housing 31 and that are to be respectively electrically connected to a plurality of pin terminals 12, which are pin-shaped partner connection members. Note that the pin terminals 12 arranged side by side are held in an external connection case 11.

JP 2019-160698A and JP 2019-207747A are examples of related art.

### SUMMARY OF THE INVENTION

When connecting the pin terminals T arranged side by side to the electrical connector disclosed in JP 2019-160698A, the pin terminals T are inserted into respective insertion openings 26 provided in the movable housing 5. When the pin terminals T are respectively inserted into the insertion openings 26 of the movable housing 5, each of the pin terminals T is electrically connected to the corresponding terminal 3 arranged inside the corresponding insertion opening 26. However, if the pin terminals T arranged side by side are inserted into the movable housing 5 at positions deviated from the insertion openings 26 of the movable housing 5, it is difficult to appropriately insert the pin terminals T into the insertion openings 26 of the movable housing 5. In this case, the pin terminals T may come into contact with partition walls 24 provided between adjacent insertion openings 26 of the movable housing 5, or may come into contact with side walls 22 on the two sides of the insertion openings 26 of the movable housing 5, which leads to the problem of difficulty in appropriately inserting the pin terminals T into the corresponding insertion openings 26.

When connecting the pin terminals 12 arranged side by side to the electrical connector disclosed in JP 2019-207747A, the pin terminals 12 are respectively inserted into the insertion openings 39 provided in the movable housing 32. When the pin terminals 12 are respectively inserted into the insertion openings 39 of the movable housing 32, each of the pin terminals 12 is electrically connected to the corresponding connector terminal 33 arranged inside the corresponding insertion opening 39. In the configuration disclosed in JP 2019-207747A, a guide mechanism is provided in order to guide the direction in which the pin terminals 12 arranged side by side are inserted into the movable housing 32 in the case where the pin terminals 12 are inserted into the movable housing 32 at positions deviated from the insertion openings 39 of the movable housing 32. The guide mechanism is provided in the movable housing 32 of the electrical connector and the external connection case 11 that holds the pin terminals 12 arranged side by side. The external connection case 11 includes, as part of the guide mechanism, guide projections 15 that project a large amount in the direction of insertion into the movable housing 32, on two sides of the pin terminals 12. The movable housing 32 is provided with a structure having surfaces that protrude a large amount on two sides of the insertion openings 39 and that guide the guide projections 15. The configuration disclosed in JP 2019-207747A therefore has problems of increased size and increased complexity of the structures of the electrical connector and the partner connected to the electrical connector.

In view of the foregoing circumstances, an object of the present invention is to provide an electrical connector that enables a plurality of pin-shaped partner connection members arranged side by side to be appropriately and easily connected thereto by insertion, and that can also suppress an increases in the size and the complexity of the structure.

(1) An electrical connector according to an aspect of the present invention for achieving the aforementioned object relates to an electrical connector to which a plurality of pin-shaped partner connection members arranged side by side are connected by being inserted into the electrical connector. This electrical connector according to this aspect of the present invention includes: a fixed housing configured to be disposed on a substrate; a movable housing configured to be mounted so as to be displaceable relative to the fixed housing; and a plurality of terminals configured to support the movable housing so as to be displaceable relative to the fixed housing, and configured to be electrically connected to the plurality of partner connection members, wherein the movable housing is provided with: a guide portion provided with an opening into which the plurality of partner connection members are inserted, and configured to guide the plurality of partner connection members from the opening into the movable housing; and a plurality of insertion holes arranged side by side inside the guide portion and configured to respectively receive insertion of the plurality of partner connection members guided by the guide portion, an inner wall of the guide portion is provided with first inclined surfaces respectively at two end sides in a width direction corresponding to a direction in which the plurality of insertion holes are arranged side by side, the first inclined surfaces being inclined relative to a height direction, which is a direction opposite to an insertion direction in which the plurality of partner connection members are inserted into the guide portion, so as to widen in a tapered manner while extending in the height direction and outward in the width direction to the opening, second inclined surfaces are provided between each pair of the insertion holes adjacent to each other in the width direction, the second inclined surfaces being inclined relative to the height direction so as to extend in a tapered manner while extending in the insertion direction and toward entrances of the insertion holes into which the plurality of partner connection members are inserted, a dimension of the first inclined surfaces in the width direction is larger than a dimension of the second inclined surfaces in the width direction, and a dimension of the first inclined surfaces in the height direction is larger than a dimension of the second inclined surfaces in the height direction.

According to this configuration, when connecting the electrical connector to the pin-shaped partner connection members arranged side by side, the partner connection members are inserted into the opening of the guide portion of the movable housing. If the partner connection members inserted into the opening of the guide portion of the movable housing are inserted into the opening without deviation in the insertion positions, the partner connection members are respectively inserted into the insertion holes inside the guide portion. The partner connection members inserted into the insertion holes are respectively electrically connected to the terminals. However, if the partner connection members inserted into the opening of the guide portion of the movable housing are inserted into the opening at insertion positions deviated in the width direction, the leading end portion of the partner connection member at one of the two end sides in the width direction among the partner connection members comes into contact with the first inclined surface at one of the two end sides in the width direction of the inner wall of the guide portion. Note that the first inclined surfaces, which are inclined so as to extend in the height direction and outward in the width direction at the two end sides in the width direction of the inner wall of the guide portion, have a larger dimension in the height direction and dimension in the width direction than the second inclined surfaces, which are inclined toward the entrances of the insertion holes between adjacent insertion holes. Therefore, if the partner connection members arranged side by side are inserted into the opening of the guide portion at positions deviated in the width direction, before the leading end portions of the partner connection members come into contact with the second inclined surfaces leading to the insertion holes, the leading end portion of the partner connection member at one of the two end sides in the width direction among the partner connection members comes into contact with the first inclined surface at the corresponding one of the two end sides in the width direction of the inner wall of the guide portion. Then, the partner connection member at one of the two end sides in the width direction slides along the corresponding first inclined surface while being inserted into the opening. Accordingly, the partner connection members arranged side by side move in the insertion direction together with the partner connection member at the one of the two end sides in the width direction that slides along the corresponding first inclined surface while being inserted into the opening, and are guided by the first inclined surface while being inserted into the guide portion. The partner connection members are guided along the inclination direction of the first inclined surface while being inserted into the guide portion, and are then respectively inserted into the insertion holes. Therefore, even if the partner connection members are inserted into the movable housing at insertion positions deviated in the width direction, the partner connection members are guided along the inclination direction of the first inclined surface while being inserted into the guide portion, and are appropriately inserted into the insertion holes. Therefore, the operation for inserting the pin-shaped partner connection members arranged side by side into the electrical connector for connection thereto can be performed appropriately and easily. Also, according to the above configuration, with a simple structure in which the movable housing is provided with the first inclined surfaces at the two end sides in the width direction of the guide portion provided with the opening, the operation for inserting the pin-shaped partner connection members arranged side by side into the electrical connector for connection thereto can be performed appropriately and easily. Therefore, it is possible to suppress an increase in the size and the complexity of the structures of the electrical connector and the partner connected to the electrical connector.

As described above, according to the above configuration, it is possible to provide the electrical connector that enables appropriately and easily performing the operation of inserting and connecting the pin-shaped partner connection members arranged side by side, and enables suppressing an increase in the size and the complexity of the structure.

(2) Another aspect is possible in which a magnitude of a smaller angle out of angles formed by the width direction and an inclination direction of each of the first inclined surfaces relative to the height direction is larger than a magnitude of a smaller angle out of angles formed by the width direction and an inclination direction of each of the second inclined surfaces relative to the height direction.

In the case where the magnitude of the smaller angle out of the angles formed by the width direction and the inclination direction of each of the first inclined surfaces relative to the height direction is the same as the magnitude of the smaller angle out of the angles formed by the width direction and the inclination direction of each of the second inclined surfaces relative to the height direction, when the partner connection members are guided along the inclination direction of one of the first inclined surfaces while being inserted into the guide portion and then reach the same height position as the second inclined surfaces, the partner connection members are then guided along both the one first inclined surface and the second inclined surfaces and respectively inserted into the insertion holes. In contrast, according to the above configuration, the smaller angle out of the angles formed by the width direction and the inclination direction of each of the first inclined surfaces relative to the height direction is set larger than the smaller angle out of the angles formed by the width direction and the inclination direction of each of the second inclined surfaces relative to the height direction. Accordingly, even when the partner connection members are guided along the inclination direction of one of the first inclined surfaces while being inserted into the guide portion and then reach the same height position as the second inclined surfaces, the partner connection members are then guided along the one first inclined surface and respectively inserted into the insertion holes substantially without sliding along the second inclined surfaces. In this way, the partner connection members inserted into the opening of the movable housing are guided along the one first inclined surface and respectively inserted into the insertion holes substantially without sliding along the second inclined surfaces. Therefore, the operation of appropriately inserting and connecting the pin-shaped partner connection members arranged side by side can be performed even more smoothly and easily.

(3) Another aspect is possible in which the inner wall of the guide portion is provided with third inclined surfaces respectively at two end sides in a front-rear direction perpendicular to both the width direction and the height direction, the third inclined surfaces being inclined relative to the height direction so as to widen in a tapered manner while extending in the height direction and outward in the front-rear direction to the opening, and a dimension of the third inclined surfaces in the height direction is larger than the dimension of the second inclined surfaces in the height direction.

According to this configuration, in the case where the partner connection members inserted into the opening of the guide portion of the movable housing are inserted into the opening at insertion positions deviated in the front-rear direction, the leading end portions of the partner connection members come into contact with the third inclined surface at one of the two end sides in the front-rear direction of the inner wall of the guide portion. Note that the third inclined surfaces, which are inclined so as to extend in the height direction and outward in the front-rear direction at the two end sides in the front-rear direction of the inner wall of the guide portion, have a larger dimension in the height direction than the second inclined surfaces, which are inclined toward the entrances of the insertion holes between adjacent insertion holes. Therefore, if the partner connection members arranged side by side are inserted into the opening of the guide portion at positions deviated in the front-rear direction, before the leading end portions of the partner connection members reach the same height as the second inclined surfaces leading to the insertion holes, the leading end portions of the partner connection members come into contact with the third inclined surface at one of the two end sides in the front-rear direction of the inner wall the guide portion. The partner connection members arranged side by side then slide along the third inclined surface while being inserted into the opening, and are guided by the third inclined surface while being inserted into the guide portion. The partner connection members are guided along the inclination direction of the third inclined surface while being inserted into the guide portion, and are then respectively inserted into the insertion holes. Therefore, even if the partner connection members are inserted into the movable housing at insertion positions deviated in the front-rear direction, the partner connection members are guided along the inclination direction of the third inclined surface while being inserted into the guide portion, and are appropriately inserted into the insertion holes. Therefore, the operation for inserting the pin-shaped partner connection members arranged side by side into the electrical connector for connection thereto can be performed appropriately and easily.

(4) An electrical connector according to another aspect of the present invention for achieving the aforementioned object relates to an electrical connector to which a plurality of pin-shaped partner connection members arranged side by side in two rows are connected by being inserted into the electrical connector. The electrical connector according to this aspect of the present invention includes: a fixed housing configured to be disposed on a substrate; a movable housing configured to be mounted so as to be displaceable relative to the fixed housing; and a plurality of terminals configured to support the movable housing so as to be displaceable relative to the fixed housing, and configured to be electrically connected to the plurality of partner connection members, wherein the movable housing is provided with: a guide portion provided with an opening into which the plurality of partner connection members are inserted, and configured to guide the plurality of partner connection members from the opening into the movable housing; and a plurality of insertion holes arranged side by side in two rows inside the guide portion and configured to respectively receive insertion of the plurality of partner connection members guided by the guide portion, an inner wall of the guide portion is provided with first inclined surfaces respectively at two end sides in a width direction corresponding to a direction in which the plurality of insertion holes are arranged side by side in two rows, the first inclined surfaces being inclined relative to a height direction, which is a direction opposite to an insertion direction in which the plurality of partner connection members are inserted into the guide portion, so as to widen in a tapered manner while extending in the height direction and outward in the width direction to the opening, second inclined surfaces are provided between each pair of the insertion holes adjacent to each other in the width direction, the second inclined surfaces being inclined relative to the height direction so as to extend in a tapered manner while extending in the insertion direction and toward entrances of the insertion holes into which the plurality of partner connection members are inserted, a dimension of the first inclined surfaces in the width direction is larger than a dimension of the second inclined surfaces in the width direction, and a dimension of the first inclined surfaces in the height direction is larger than a dimension of the second inclined surfaces in the height direction.

According to this configuration, when connecting the pin-shaped partner connection members arranged side by side in two rows to the electrical connector, the partner connection members are inserted into the opening of the guide portion of the movable housing. If the partner connection members inserted into the opening of the guide portion of the movable housing are inserted into the opening without deviation in the insertion positions, the partner connection members are respectively inserted into the insertion holes inside the guide portion. The partner connection members inserted into the insertion holes are respectively electrically connected to the terminals. However, if the partner connection members inserted into the opening of the guide portion of the movable housing are inserted into the opening at insertion positions deviated in the width direction, the leading end portions of the partner connection members at one of the two end sides in the width direction, among the partner connection members arranged side by side in two rows, come into contact with the first inclined surface at one of the two end sides in the width direction of the inner wall of the guide portion. Note that the first inclined surfaces, which are inclined so as to extend in the height direction and outward in the width direction at the two end sides in the width direction of the inner wall of the guide portion, have a larger dimension in the height direction and dimension in the width direction than the second inclined surfaces, which are inclined toward the entrances of the insertion holes between insertion holes adjacent in the width direction. Therefore, if the partner connection members arranged side by side in two rows are inserted into the opening of the guide portion at positions deviated in the width direction, before the leading end portions of the partner connection members come into contact with the second inclined surfaces leading to the insertion holes, the leading end portions of the partner connection members at one of the two end sides in the width direction among the partner connection members come into contact with the first inclined surface at the corresponding one of the two end sides in the width direction of the inner wall of the guide portion. Then, the partner connection member at one of the two end sides in the width direction slides along the corresponding first inclined surface while being inserted into the opening. Accordingly, the partner connection members arranged side by side in two rows move together with the partner connection members at the one of the two end sides in the width direction that slide along the corresponding first inclined surface while being inserted into the opening, and are guided by the first inclined surface while being inserted into the guide portion. The partner connection members are guided along the inclination direction of the first inclined surface while being inserted into the guide portion, and are then respectively inserted into the insertion holes. Therefore, even if the partner connection members are inserted into the movable housing at insertion positions deviated in the width direction, the partner connection members are guided along the inclination direction of the first inclined surface while being inserted into the guide portion, and are appropriately inserted into the insertion holes. Therefore, the operation for inserting the pin-shaped partner connection members arranged side by side in two rows into the electrical connector for connection thereto can be performed appropriately and easily. Also, according to the above configuration, with a simple structure in which the movable housing includes the first inclined surfaces at the two end sides in the width direction of the guide portion provided with the opening, the operation for inserting the pin-shaped partner connection members arranged side by side in two rows into the electrical connector for connection thereto can be performed appropriately and easily. Therefore, it is possible to suppress an increase in the size and the complexity of the structures of the electrical connector and the partner connected to the electrical connector.

As described above, according to the above configuration, it is possible to provide the electrical connector that enables appropriately and easily performing the operation of inserting and connecting the pin-shaped partner connection members arranged side by side in two rows, and enables suppressing an increase in the size and the complexity of the structure.

(5) Another aspect is possible in which a magnitude of a smaller angle out of angles formed by the width direction and an inclination direction of each of the first inclined surfaces relative to the height direction is larger than a magnitude of a smaller angle out of angles formed by the width direction and an inclination direction of each of the second inclined surfaces relative to the height direction.

In the case where the magnitude of the smaller angle out of the angles formed by the width direction and the inclination direction of each of the first inclined surfaces relative to the height direction is the same as the magnitude of the smaller angle out of the angles formed by the width direction and the inclination direction of each of the second inclined surfaces relative to the height direction, when the partner connection members are guided along the inclination direction of one of the first inclined surfaces while being inserted into the guide portion and then reach the same height position as the second inclined surfaces, the partner connection members are then guided along both the one first inclined surface and the second inclined surfaces and respectively inserted into the insertion holes. In contrast, according to the above configuration, the smaller angle out of the angles formed by the width direction and the inclination direction of each of the first inclined surfaces relative to the height direction is set larger than the smaller angle out of the angles formed by the width direction and the inclination direction of each of the second inclined surfaces relative to the height direction. Accordingly, even when the partner connection members are guided along the inclination direction of one of the first inclined surfaces while being inserted into the guide portion and then reach the same height position as the second inclined surfaces, the partner connection members are then guided along the one first inclined surface and respectively inserted into the insertion holes substantially without sliding along the second inclined surfaces. In this way, the partner connection members inserted into the opening of the movable housing are guided along the one first inclined surface and respectively inserted into the insertion holes substantially without sliding along the second inclined surfaces. Therefore, the operation of appropriately inserting and connecting the pin-shaped partner connection members arranged side by side in two rows can be performed even more smoothly and easily.

(6) Another aspect is possible in which the inner wall of the guide portion is provided with third inclined surfaces respectively at two end sides in a front-rear direction perpendicular to both the width direction and the height direction, the third inclined surfaces being inclined relative to the height direction so as to widen in a tapered manner while extending in the height direction and outward in the front-rear direction to the opening, fourth inclined surfaces are provided between each pair of the insertion holes adjacent to each other in the front-rear direction, the fourth inclined surfaces being inclined relative to the height direction so as to extend in a tapered manner while extending in the insertion direction and toward the entrances of the insertion holes, a dimension of the third inclined surfaces in the front-rear direction is larger than a dimension of the fourth inclined surfaces in the front-rear direction, and a dimension of the third inclined surfaces in the height direction is larger than the dimension of the fourth inclined surfaces in the height direction.

According to this configuration, in the case where the pin-shaped partner connection members arranged side by side in two rows are inserted into the opening of the guide portion of the movable housing at insertion positions deviated in the front-rear direction, the leading end portions of the partner connection members arranged side by side in the row on one side in the front-rear direction, among the partner connection members arranged side by side in two rows, come into contact with the third inclined surface at one of the two end sides in the front-rear direction of the inner wall of the guide portion. Note that the third inclined surfaces, which are inclined so as to extend in the height direction and outward in the front-rear direction at the two end sides in the front-rear direction of the inner wall of the guide portion, have a larger dimension in the height direction and dimension in the front-rear direction than the fourth inclined surfaces, which are inclined toward the entrances of the insertion holes between insertion holes adjacent in the front-rear direction. Therefore, if the partner connection members arranged side by side in two rows are inserted into the opening of the guide portion at positions deviated in the front-rear direction, before the leading end portions of the partner connection members reach the same height as the fourth inclined surfaces leading to the insertion holes, the leading end portions of the partner connection members arranged side by side in the row on one side in the front-rear direction come into contact with the third inclined surface at one of the two end sides in the front-rear direction of the inner wall the guide portion. The partner connection members then slide along the third inclined surface while being inserted into the opening. As a result, the partner connection members arranged side by side in two rows move together with the partner connection members that are arranged side by side in the row on one side in the front-rear direction and slide along the corresponding third inclined surface while being inserted into the opening, and are guided by the third inclined surface while being inserted into the guide portion. The partner connection members are guided along the inclination direction of the third inclined surface while being inserted into the guide portion, and are then respectively inserted into the insertion holes. Therefore, even if the partner connection members are inserted into the movable housing at insertion positions deviated in the front-rear direction, the partner connection members are guided along the inclination direction of the third inclined surface while being inserted into the guide portion, and are appropriately inserted into the insertion holes. Therefore, the operation for inserting the pin-shaped partner connection members arranged side by side in two rows into the electrical connector for connection thereto can be performed appropriately and easily.

(7) Another aspect is possible in which a magnitude of a smaller angle out of angles formed by the front-rear direction and an inclination direction of each of the third inclined surfaces relative to the height direction is larger than a magnitude of a smaller angle out of angles formed by the front-rear direction and an inclination direction of each of the fourth inclined surfaces relative to the height direction.

In the case where the magnitude of the smaller angle out of the angles formed by the front-rear direction and the inclination direction of each of the third inclined surfaces relative to the height direction is the same as the magnitude of the smaller angle out of the angles formed by the front-rear direction and the inclination direction of each of the fourth inclined surfaces relative to the height direction, when the partner connection members are guided along the inclination direction of one of the third inclined surfaces while being inserted into the guide portion and then reach the same height position as the fourth inclined surfaces, the partner connection members are then guided along both the one third inclined surface and the fourth inclined surfaces and respectively inserted into the insertion holes. In contrast, according to the above configuration, the smaller angle out of the angles formed by the front-rear direction and the inclination direction of each of the third inclined surfaces relative to the height direction is set larger than the smaller angle out of the angles formed by the front-rear direction and the inclination direction of each of the fourth inclined surfaces relative to the height direction. Accordingly, even when the partner connection members are guided along the inclination direction of one of the third inclined surfaces while being inserted into the guide portion and then reach the same height position as the fourth inclined surfaces, the partner connection members are then guided along the one third inclined surface and respectively inserted into the insertion holes substantially without sliding along the fourth inclined surfaces. In this way, the partner connection members inserted into the opening of the movable housing are guided along the one third inclined surface and respectively inserted into the insertion holes substantially without sliding along the fourth inclined surfaces. Therefore, the operation of appropriately inserting and connecting the pin-shaped partner connection members arranged side by side in two rows can be performed even more smoothly and easily.

The above and other objects, features, and advantages of the present invention will become apparent from reading the following description together with the accompanying drawings.

### BRIEF DESCRIPTION OF THE DRAWINGS

FIG. 1 is a perspective view of an electrical connector according to a first embodiment of the present invention together with a substrate and a partner connector.

FIG. 2 is a perspective view of the electrical connector.

FIG. 3 is an exploded perspective view of the electrical connector.

FIG. 4 is a perspective view of the electrical connector and includes a cross section taken along a plane perpendicular to the width direction of the electrical connector.

FIG. 5A is a side view of the electrical connector, and FIG. 5B is a cross-sectional view of the electrical connector taken along a line A-Ain FIG. 5A.

FIG. 6A is a front view of the electrical connector, and FIG. 6B is a cross-sectional view of the electrical connector taken along a line B-B in FIG. 6A.

FIG. 7 is a cross-sectional view illustrating a state in which the electrical connector and the partner connector are connected, the cross section being taken along a plane perpendicular to the front-rear direction of the electrical connector.

FIG. 8 is a cross-sectional view illustrating a state in which the electrical connector and the partner connector are connected, the cross section being taken along a plane perpendicular to the width direction of the electrical connector.

FIG. 9 is a perspective view of a fixed housing of the electrical connector.

FIG. 10 is a perspective view of a movable housing of the electrical connector.

FIG. 11 is an enlarged view of a portion of FIG. 5B.

FIG. 12 is an enlarged view of a portion of FIG. 6B.

FIG. 13 is a perspective view of a terminal of the electrical connector.

FIG. 14 is a side view illustrating a state immediately before pin-shaped partner connection members of the partner connector are inserted into the electrical connector, with the fixed housing being omitted from the electrical connector.

FIG. 15 is a cross-sectional view taken along a line C-C in FIG. 14.

FIG. 16 is a cross-sectional view illustrating a state in which pin-shaped partner connection members of the partner connector are being inserted into the electrical connector, the cross section being taken at a position corresponding to the line C-C in FIG. 14.

FIG. 17 is a cross-sectional view illustrating a state in which pin-shaped partner connection members of the partner connector are being inserted into the electrical connector, the cross section being taken at a position corresponding to the line C-C in FIG. 14.

FIG. 18 is a front view illustrating a state immediately before pin-shaped partner connection members of the partner connector are inserted into the electrical connector, with the fixed housing being omitted from the electrical connector.

FIG. 19 is a cross-sectional view taken along a line D-D in FIG. 18.

FIG. 20 is a cross-sectional view illustrating a state in which pin-shaped partner connection members of the partner connector are being inserted into the electrical connector, the cross section being taken at a position corresponding to the line D-D in FIG. 18.

FIG. 21 is a perspective view of an electrical connector according to a second embodiment of the present invention together with a substrate and a partner connector.

FIG. 22 is a perspective view of the electrical connector.

FIG. 23 is a perspective view of the electrical connector and includes a cross section taken along a plane perpendicular to the width direction of the electrical connector.

FIG. 24A is a front view of the electrical connector, and FIG. 24B is a side view of the electrical connector.

FIG. 25 is a cross-sectional view taken along a line E-E in FIG. 24A.

FIG. 26 is a cross-sectional view taken along a line F-F in FIG. 24B.

FIG. 27 is an enlarged view of a portion of FIG. 26.

FIG. 28 is an enlarged view of a portion of FIG. 25.

FIG. 29 is a side view illustrating a state immediately before pin-shaped partner connection members of the partner connector are inserted into the electrical connector, with the fixed housing being omitted from the electrical connector.

FIG. 30 is a cross-sectional view taken along a line G-G in FIG. 29.

FIG. 31 is a cross-sectional view illustrating a state in which pin-shaped partner connection members of the partner connector are being inserted into the electrical connector, the cross section being taken at a position corresponding to the line G-G in FIG. 29.

FIG. 32 is a cross-sectional view illustrating a state in which pin-shaped partner connection members of the partner connector are being inserted into the electrical connector, the cross section being taken at a position corresponding to the line G-G in FIG. 29.

FIG. 33 is a front view illustrating a state immediately before pin-shaped partner connection members of the partner connector are inserted into the electrical connector, with the fixed housing being omitted from the electrical connector.

FIG. 34 is a cross-sectional view taken along a line H-H in FIG. 33.

FIG. 35 is a cross-sectional view illustrating a state in which pin-shaped partner connection members of the partner connector are being inserted into the electrical connector, the cross section being taken at a position corresponding to the line H-H in FIG. 33.

FIG. 36 is a perspective view of an electrical connector according to a variation together with a substrate.

FIG. 37 is a front view of the electrical connector.

FIG. 38 is a cross-sectional view taken along a line I-I in FIG. 37.

FIG. 39 is a cross-sectional view taken along a line J-J in FIG. 37.

### DETAILED DESCRIPTION OF THE INVENTION

Hereinafter, embodiments for carrying out the present invention will be described with reference to the drawings. Note that the present invention is broadly applicable in various applications as an electrical connector to which a plurality of pin-shaped partner connection members arranged side by side are connected by being inserted into the electrical connector, the electrical connector including a fixed housing to be disposed on a substrate, a movable housing mounted so as to be displaceable relative to the fixed housing, and a plurality of terminals that support the movable housing so as to be displaceable relative to the fixed housing.

### First Embodiment

### Overall Configuration of Electrical Connector

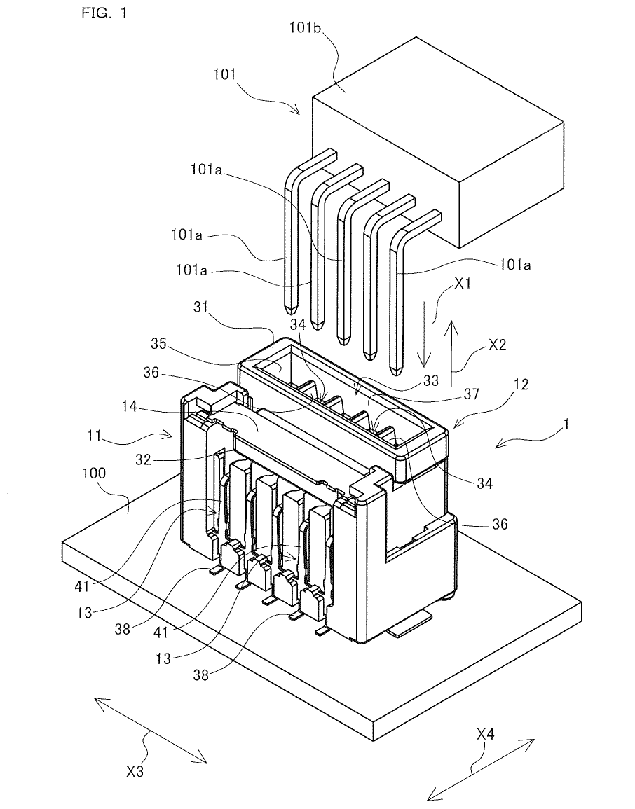

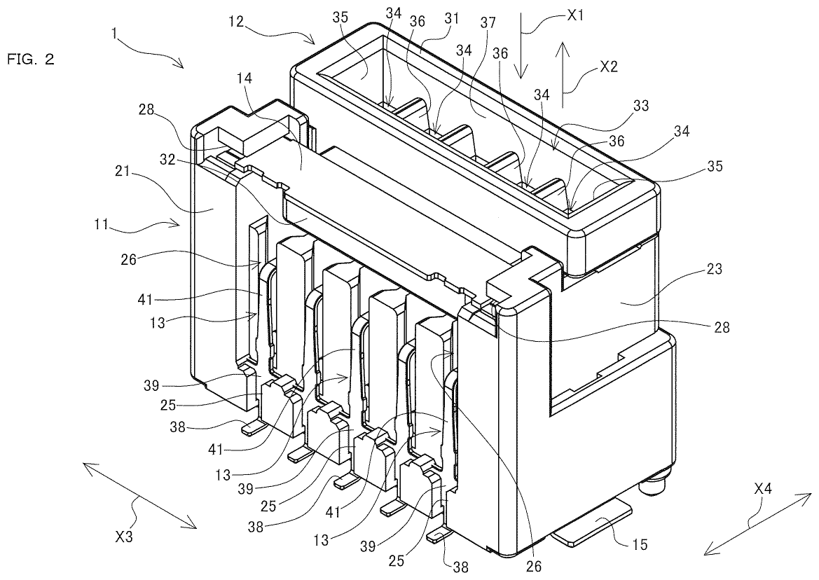

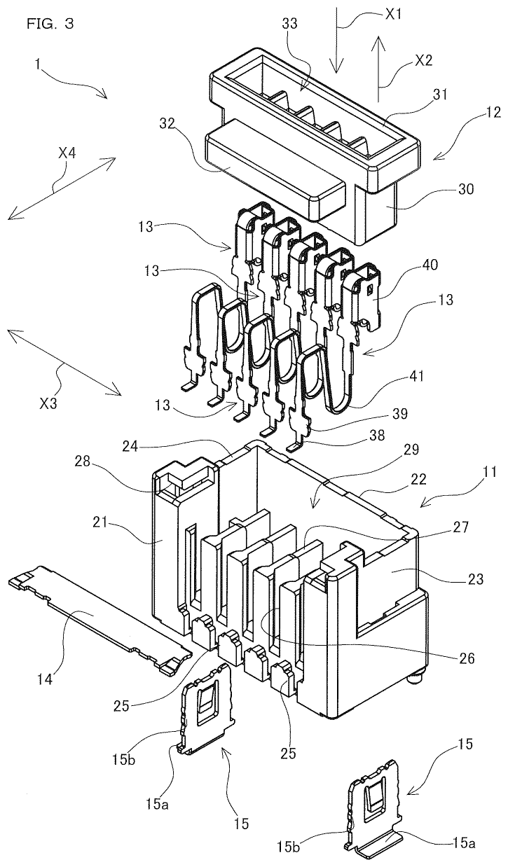

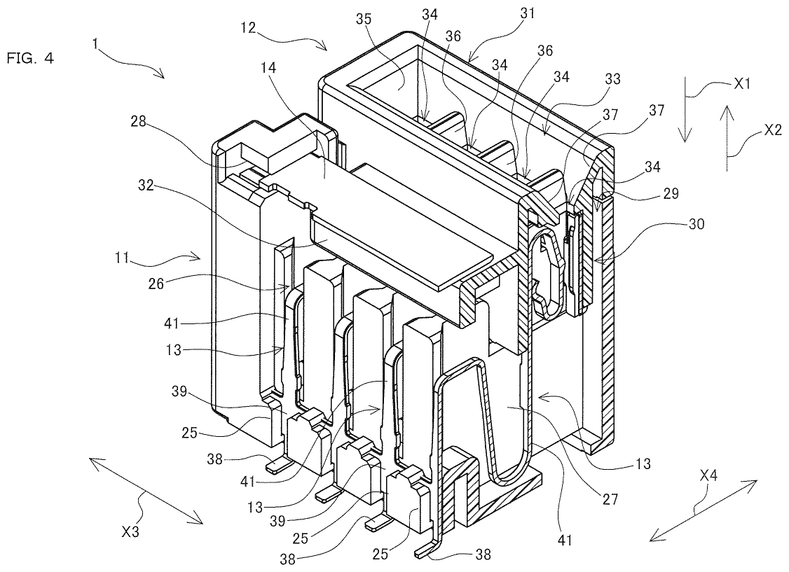

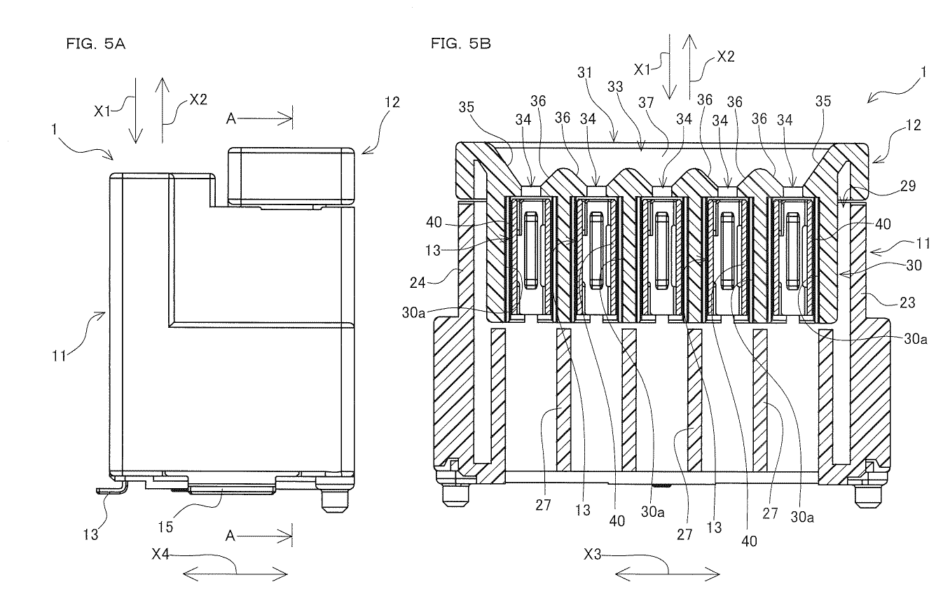

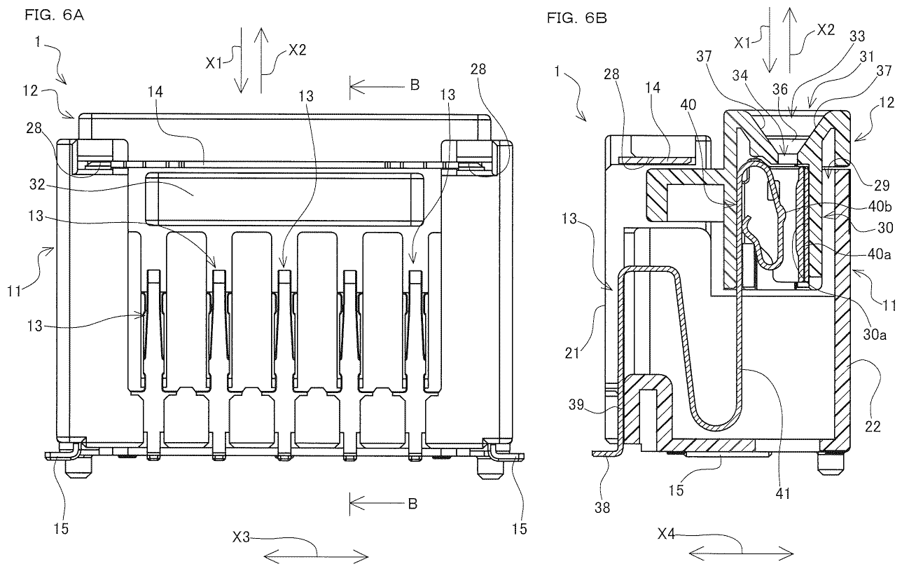

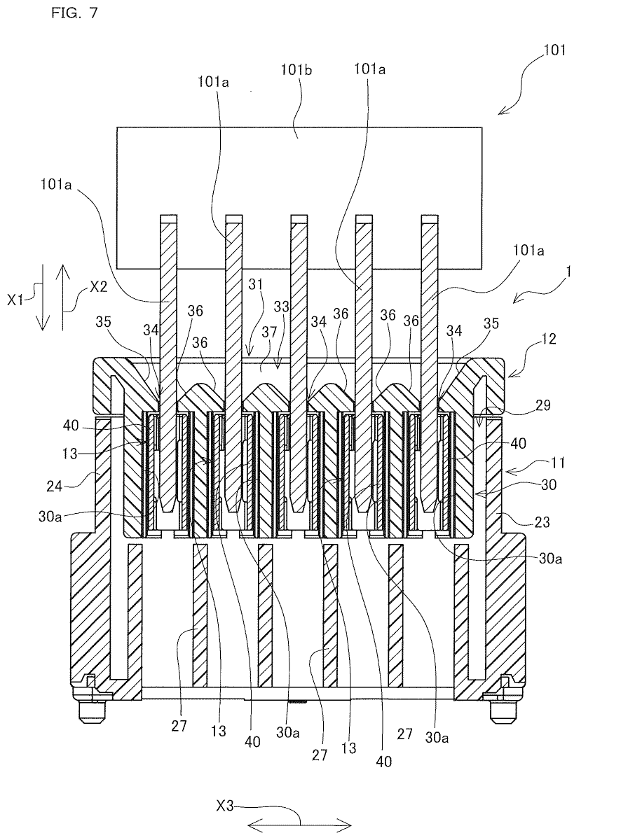

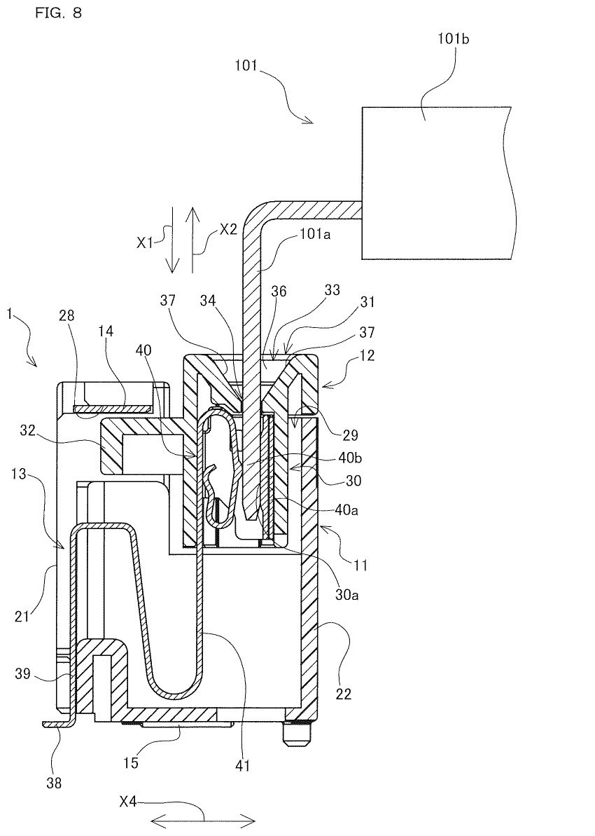

FIG. 1 is a perspective view of an electrical connector 1 according to a first embodiment of the present invention together with a substrate 100 and a partner connector 101. Note that FIG. 1 shows a state in which the electrical connector 1 is disposed on the substrate 100 and electrically connected to the substrate 100, and in which the partner connector 101 has not been connected to the electrical connector 1. FIG. 2 is a perspective view of the electrical connector 1. FIG. 3 is an exploded perspective view of the electrical connector 1. FIG. 4 is a perspective view of the electrical connector 1 and includes a cross section taken along a plane perpendicular to the width direction of the electrical connector 1. FIG. 5A is a side view of the electrical connector 1, and FIG. 5B is a cross-sectional view of the electrical connector 1 taken along a line A-A in FIG. 5A FIG. 6A is a front view of the electrical connector 1, and FIG. 6B is a cross-sectional view of the electrical connector 1 taken along a line B-B in FIG. 6A. FIG. 7 is a cross-sectional view illustrating a state in which the electrical connector 1 and the partner connector 101 are connected, the cross section being taken along a plane perpendicular to the front-rear direction of the electrical connector 1. FIG. 8 is a cross-sectional view illustrating a state in which the electrical connector 1 and the partner connector 101 are connected, the cross section being taken along a plane perpendicular to the width direction of the electrical connector 1. Note that in FIGS. 7 and 8, the electrical connector 1 is shown in a cross-sectional view, and only a part of the partner connector 101 is shown in a cross-sectional view.

The electrical connector 1 shown in FIGS. 1 to 8 is configured as an electrical connector that is to be electrically connected to the partner connector 101 having a plurality of pin-shaped partner connection members 101a arranged side by side. The electrical connector 1 is configured as an electrical connector to which the pin-shaped partner connection members 101a arranged side by side in the partner connector 101 are connected by being inserted therein.

As shown in FIGS. 1 to 8, the electrical connector 1 includes a fixed housing 11, a movable housing 12, a plurality of terminals 13, a movement restricting member 14, and a pair of fixing fittings 15. The fixed housing 11 and the movable housing 12 are made of a resin material that has insulating properties. The terminals 13 are made of a metal material that has electrical conductive properties. The movement restricting member 14 and the pair of fixing fitting 15 are made of a metal material. The fixed housing 11 is configured to be disposed on the substrate 100. The movable housing 12 is configured to be mounted so as to be displaceable relative to the fixed housing 11. The terminals 13 are configured to support the movable housing 12 so as to be displaceable relative to the fixed housing 11, and are configured to be respectively electrically connected to the pin-shaped partner connection members 101a. Note that the movable housing 12 is loosely inserted into and mounted to the fixed housing 11. The movement restricting member 14 is attached to the fixed housing 11 after the movable housing 12 has been loosely inserted into and mounted to the fixed housing 11. The movement restricting member 14 is provided so as to be able to come into contact with the movable housing 12 that has been loosely inserted into and mounted to the fixed housing 11. The movement restricting member 14 restricts the amount of displacement of the movable housing 12 relative to the fixed housing 11 by coming into contact with the movable housing 12, and prevents the movable housing 12 from coming out of the fixed housing 11.

The electrical connector 1 is mechanically and electrically connected to the substrate 100 by being disposed on and mounted to the substrate 100. Note that when the electrical connector 1 is connected to the substrate 100, the terminals 13 of the electrical connector 1 are soldered to the substrate 100, and the pair of fixing fittings 15 of the electrical connector 1 are also soldered to the substrate 100. Also, the electrical connector 1 is mechanically and electrically connected to the partner connector 101 while disposed on the substrate 100. Due to the electrical connector 1 being connected to the partner connector 101 while disposed on the substrate 100, the substrate 100 and the partner connector 101 are electrically connected via the electrical connector 1.

Regarding the substrate 100 on which the electrical connector 1 is disposed, only a partial cutout is schematically shown in FIG. 1, that is to say, only the portion where the electrical connector 1 is disposed and the vicinity thereof are illustrated. The substrate 100 on which the electrical connector 1 is disposed is configured as a substrate having a conductive circuit pattern provided on the surface. The conductive circuit pattern of the substrate 100 is not shown in FIG. 1. The substrate 100 is used as a substrate for provision in a vehicle-mounted device (not shown), for example.

The partner connector 101 for connection to the electrical connector 1 includes a plurality of pin-shaped partner connection members 101a arranged side by side, and a partner housing 101b that holds the partner connection members 101a. Note that only a partial cutout of the partner housing 101b is shown in FIG. 1. The pin-shaped partner connection members 101a are held in the partner housing 101b in a state of being arranged side by side at equal intervals in one row. The partner connector 101 is connected to a power supply unit (not shown) that supplies power to a vehicle-mounted device in which the substrate 100 is provided, for example.

Note that the partner connection members 101a of the partner connector 101 are pin-shaped and formed from a metal material that has electrical conductive properties, and are provided as male pin terminals in the present embodiment. When connecting the partner connector 101 to the electrical connector 1, the pin-shaped partner connection members 101a arranged side by side in one row in the partner connector 101 are inserted into the movable housing 12 of the electrical connector 1. Upon being inserted into the movable housing 12, the pin-shaped partner connection members 101a respectively come into contact with the terminals 13 of the electrical connector 1 inside the movable housing 12. When the partner connection members 101a and the terminals 13 are in contact with each other inside the movable housing 12, the partner connection members 101a and the terminals 13 are respectively electrically connected to each other. In this way, the electrical connector 1 is configured such that the pin-shaped partner connection members 101a arranged side by side connected thereto by being inserted therein.

A more detailed configuration of the electrical connector 1 will be described below. Note that in the following description, an insertion direction X1, a height direction X2, a width direction X3, and a front-rear direction X4 of the electrical connector 1 are respectively defined as shown by an arrow X1, an arrow X2, a double-headed arrow X3, and a double-headed arrow X4 in FIGS. 1 to 8 and later-described drawings. The insertion direction X1 is a direction in which the pin-shaped partner connection members 101a are inserted into and connected to the movable housing 12 in the electrical connector 1. Note that the pin-shaped partner connection members 101a are inserted into the movable housing 12 via a later-described a guide portion 31 of the movable housing 12. The insertion direction X1 is also the direction in which the movable housing 12 is inserted into and mounted to the fixed housing 11. The height direction X2 is a direction opposite to the insertion direction X1. In other words, the height direction X2 is parallel with and opposite to the insertion direction X1, and is opposite to the direction in which the partner connection members 101a are inserted into the movable housing 12. The width direction X3 is the arrangement direction of a plurality of later-described insertion holes 34 that are arranged side by side inside the later-described guide portion 31 of the movable housing 12 and respectively receive insertion of the partner connection members 101a. Note that the width direction X3, which is the arrangement direction of the insertion holes 34 inside the guide portion 31 of the movable housing 12, is also the pitch direction of the terminals 13 arranged side by side in a row in the fixed housing 11. The front-rear direction X4 is a direction perpendicular to both the height direction X2 and the width direction X3. In other words, the front-rear direction X4 is a direction that is perpendicular to the height direction X2 and the insertion direction X1 and also perpendicular to the width direction X3.

### Fixed Housing

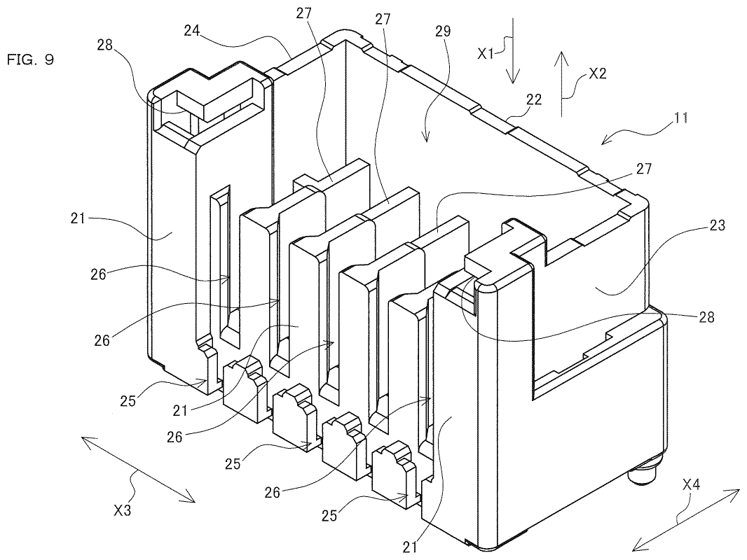

FIG. 9 is a perspective view of the fixed housing 11 of the electrical connector 1. The fixed housing 11 shown in FIGS. 1 to 9 is configured to hold the terminals 13, and is the member that the movable housing 12 is inserted into and mounted to. Furthermore, the fixed housing 11 is configured to be disposed on the substrate 100 via the terminals 13 and the pair of fixing fittings 15.

The fixed housing 11 includes a terminal holding wall 21 that holds the terminals 13, a back wall 22 that faces the terminal holding wall 21 in the front-rear direction X4, and a pair of side walls 23 and 24 that extend perpendicularly to the terminal holding wall 21 and the back wall 22. The terminal holding wall 21, the side wall 23, the back wall 22, and the side wall 24 are arranged so as to form a rectangular cross section in a plane perpendicular to the insertion direction X1, and are integrated to form four outer peripheral surfaces of the fixed housing 11. Therefore, the fixed housing 11 has a basic outer shape of a substantially rectangular parallelepiped.

The terminal holding wall 21 is provided as a wall portion on one end side of the fixed housing 11 in the front-rear direction X4, and is configured to hold the terminals 13. The terminal holding wall 21 is provided with a plurality of terminal fixing portions 25 into which later-described fixing portions 39 of the terminals 13 are respectively press-fitted and fixed. The terminal fixing portions 25 are provided in the terminal holding wall 21 on the end side in the insertion direction X1, and are arranged side by side along the width direction X3. Each of the terminal fixing portions 25 has a pair of press-fitting grooves into which the later-described fixing portion 39 of a corresponding terminal 13 is press-fitted. By press-fitting the fixing portion 39 of the terminal 13 into the pair of press-fitting grooves of the terminal fixing portion 25, the terminal 13 is fixed and held by the terminal holding wall 21.

The terminal holding wall 21 is also provided with a plurality of slits 26. The slits 26 are provided side by side along the width direction X3 in the terminal holding wall 21, and are provided at positions respectively corresponding to the terminal fixing portions 25 in a direction parallel with the insertion direction X1. The slits 26 are provided so as to pass through the terminal holding wall 21 in a direction parallel with the front-rear direction X4 and extend along a direction parallel with the insertion direction X1. Portions of later-described movable spring portions 41 of the terminals 13 held by the terminal holding wall 21 are respectively arranged in the slits 26.

Also, as shown in FIGS. 3 to 5B, 6B, and 7 to 9, the fixed housing 11 is provided with a plurality of partition walls 27 that extend from the terminal holding wall 21 toward the inside of the fixed housing 11. The partition walls 27 are provided side by side along the width direction X3 inside the fixed housing 11. Also, the partition walls 27 extend from the terminal holding wall 21 along a direction parallel with the front-rear direction X4 inside the fixed housing 11. The partition walls 27 are provided as inner walls that partition the terminals 13 arranged side by side along the width direction X3 in the fixed housing 11. In other words, in the fixed housing 11, among the terminals 13 arranged side by side along the width direction X3, each pair of adjacent terminals 13 is partitioned by one of the partition walls 27.

Also, as shown in FIGS. 2 to 4, 6A, 6B, 8, and 9, the fixed housing 11 is provided with a pair of attachment grooves 28 to which the movement restricting member 14 is attached. The pair of attachment grooves 28 are provided in the end portion of the fixed housing 11 in the height direction X2, on respective end sides in the width direction X3. By press-fitting the two end portions of the movement restricting member 14 in the width direction X3 into the pair of attachment grooves 28, the movement restricting member 14 is fixed and attached to the fixed housing 11. The movement restricting member 14 is provided as a flat plate-like member, and is provided as a member that restricts the amount of displacement, relative to the fixed housing 11, of the movable housing 12 mounted by being loosely inserted into the fixed housing 11, and that prevents the movable housing 12 from coming out of the fixed housing 11. After the movable housing 12 has been inserted into the fixed housing 11, the movement restricting member 14 is fixed by being press-fitted into the attachment groove 28 of the fixed housing 11. The movement restricting member 14 is provided so as to come into contact with a later-described protrusion portion 32 of the movable housing 12 in the height direction X2 in this state. When the movement restricting member 14 attached to the fixed housing 11 and the protrusion portion 32 of the movable housing 12 inserted into the fixed housing 11 come into contact with each other, the amount of displacement of the movable housing 12 in the height direction X2 is restricted, and the movable housing 12 is prevented from coming out of the fixed housing 11.

Also, as shown in FIGS. 3 to 9, the fixed housing 11 is provided with an insertion opening 29 into which the movable housing 12 is loosely inserted. The insertion opening 29 is provided as a hole that exposes the interior of the fixed housing 11 to the outside, and is open in the height direction X2. Also, the insertion opening 29 is provided as an area inside the fixed housing 11 surrounded by the partition walls 27 projecting from the terminal holding wall 21 to the inside of the fixed housing 11, the side wall 23, the back wall 22, and the side wall 24.

Also, as shown in FIGS. 2, 3, 5A, 6A, and 6B, the fixed housing 11 is configured such that the fixing fittings 15 are attached to the side walls 23 and 24. A press-fitting groove into which the corresponding fixing fitting 15 is press-fitted is provided in the side walls 23 and 24, at the end portion thereof in the insertion direction X1. By the fixing fittings 15 being press-fitted into the press-fitting grooves provided in the side walls 23 and 24, the fixing fittings 15 are attached to the side walls 23 and 24. Note that each of the fixing fittings 15 includes a press-fitting portion 15b that is press-fitted into the press-fitting groove of the side wall 23 or 24, and a soldering portion 15a that is bent relative to the press-fitting portion 15b and is fixed to the substrate 100 by soldering.

### Movable Housing

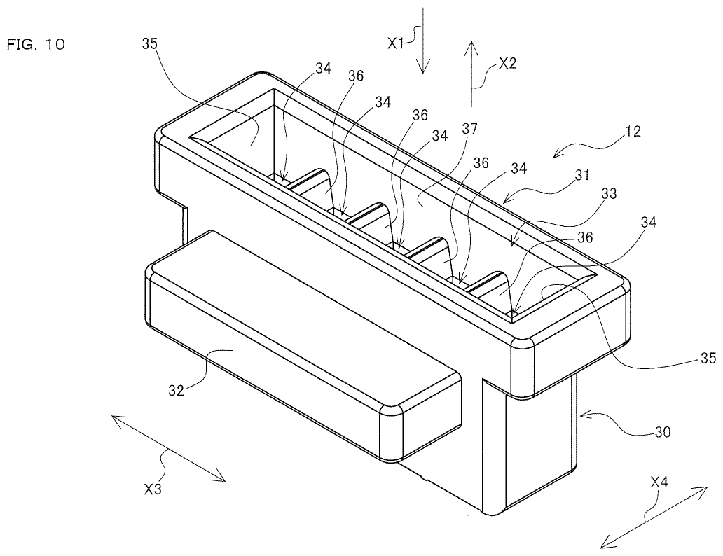

FIG. 10 is a perspective view of the movable housing 12 of the electrical connector 1. The movable housing 12 shown in FIGS. 1 to 8 and 10 is loosely inserted into the insertion opening 29 of the fixed housing 11 and mounted so as to be displaceable relative to the fixed housing 11. Also, the movable housing 12 is supported via the terminals 13 so as to be displaceable relative to the fixed housing 11. The movable housing 12 is provided with a body portion 30 that is inserted into the insertion opening 29 of the fixed housing 11, and a guide portion 31 for guiding reception of the partner connection members 101a in the movable housing 12 when the partner connection members 101a are inserted into the movable housing 12. The guide portion 31 is integrated with the body portion 30 on the end side of the body portion 30 in the height direction X2.

The body portion 30 is formed as a portion having a basic outer shape of a substantially rectangular parallelepiped elongated along the width direction X3, and is loosely inserted into the insertion opening 29 of the fixed housing 11. Due to being loosely inserted into the insertion opening 29 of the fixed housing 11, the body portion 30 is arranged so as to be relatively displaceable inside the insertion opening 29. Note that when the body portion 30 is inserted into the insertion opening 29, the body portion 30 is supported by the fixed housing 11 via the terminals 13.

Also, the cross-sectional area of a cross section, taken perpendicular to the insertion direction X1, of the insertion opening 29 into which the body portion 30 is inserted is larger than the cross-sectional area of a cross section, taken perpendicular to the insertion direction X1, of the portion of the body portion 30 that is inserted into the insertion opening 29. Therefore, when the body portion 30 inserted into the insertion opening 29 undergoes displacement in the width direction X3 and the front-rear direction X4 in the insertion opening 29, the amount of displacement in the width direction X3 and the front-rear direction X4 is restricted to a predetermined displacement amount or less. Therefore, in the electrical connector 1, the insertion opening 29 of the fixed housing 11 is provided so as to restrict the amount of displacement of the body portion 30 of the movable housing 12 relative to the fixed housing 11 in both the width direction X3 and the front-rear direction X4.

As shown in FIGS. 5A, 5B, and 7, when the body portion 30 is inserted into the insertion opening 29 of the fixed housing 11 and supported by the fixed housing 11 via the terminals 13, the two end portions of the body portion 30 in the width direction X3 are separated from the pair of side walls 23 and 24 by gaps. Specifically, a gap is formed between one end portion of the body portion 30 in the width direction X3 and the side wall 23, and a gap is also formed between the other end portion of the body portion 30 in the width direction X3 and the side wall 24. When the body portion 30 undergoes displacement in the width direction X3, an end portion of the body portion 30 in the width direction X3 comes into contact with the side wall 23 or the side wall 24, and the amount of displacement of the body portion 30 in the width direction X3 is restricted. Accordingly, the amount of displacement of the body portion 30 inserted into the insertion opening 29 relative to the fixed housing 11 in the width direction X3 is restricted. In other words, when the body portion 30 is inserted into the insertion opening 29, the amount of displacement of the movable housing 12 relative to the fixed housing 11 in the width direction X3 is restricted.

Also, as shown in FIGS. 6A, 6B, and 8, when the body portion 30 is inserted into the insertion opening 29 of the fixed housing 11 and is supported by the fixed housing 11 via the terminals 13, the two end portions of the body portion 30 in the front-rear direction X4 are separated from the partition walls 27 and the back wall 22 by gaps. Specifically, a gap is formed between one end portion of the body portion 30 in the front-rear direction X4 and the partition walls 27, and a gap is also formed between the other end portion of the body portion 30 in the front-rear direction X4 and the back wall 22. When the body portion 30 undergoes displacement in the front-rear direction X4, an end portion of the body portion 30 in the front-rear direction X4 comes into contact with the partition walls 27 or the back wall 22, and the amount of displacement of the body portion 30 in the front-rear direction X4 is restricted. Accordingly, the amount of displacement of the body portion 30 inserted into the insertion opening 29 relative to the fixed housing 11 in the front-rear direction X4 is restricted. In other words, when the body portion 30 is inserted into the insertion opening 29, the amount of displacement of the movable housing 12 relative to the fixed housing 11 in the front-rear direction X4 is restricted.

Also, as shown in FIGS. 5A to 8, the body portion 30 is provided with a plurality of holding chambers 30a that accommodate and hold later-described partner connection portions 40 of the terminals 13. The holding chambers 30a are provided as spatial regions inside the body portion 30, and are arranged side by side in the width direction X3 inside the body portion 30. Also, each of the holding chambers 30a is provided as a substantially rectangular parallelepiped spatial region inside the body portion 30, and is open in the insertion direction X1. The partner connection portions 40 of the terminals 13 are inserted in the height direction X2 into the holding chambers 30a through the openings of the holding chambers 30a. The partner connection portions 40 of the terminals 13 are inserted and press-fitted into the holding chambers 30a, and are held in the holding chambers 30a.

Also, the body portion 30 is provided with a protrusion portion 32 that projects along the front-rear direction X4. The protrusion portion 32 is shaped as a substantially rectangular parallelepiped elongated along the width direction X3, and is provided as a portion projecting from the body portion 30 as a protrusion along the front-rear direction X4. The protrusion portion 32 is provided so as to project in the front-rear direction X4 from the body portion 30 toward the terminal holding wall 21 to which the terminals 13 are fixed in the fixed housing 11 when the body portion 30 is inserted into the insertion opening 29. Note that each of the terminals 13 is provided with a fixing portion 39 as a portion that is fixed to the terminal holding wall 21 of the fixed housing 11. Therefore, the protrusion portion 32 is provided so as to project in the front-rear direction X4 from the body portion 30 toward the side of the fixed housing 11 to which the fixing portions 39 of the terminals 13 are fixed when the body portion 30 is inserted into the insertion opening 29.

The protrusion portion 32 projecting from the body portion 30 along the front-rear direction X4 is arranged such that, when the movable housing 12 is mounted to the fixed housing 11, the protrusion portion 32 projects along the front-rear direction X4 between the partition walls 27 of the fixed housing 11 and the movement restricting member 14 attached to the fixed housing 11. Therefore, the protrusion portion 32 is arranged so as to face the partition walls 27 of the fixed housing 11 in the insertion direction X1, and to face the movement restricting member 14 in the height direction X2. A gap is formed between the protrusion portion 32 and the partition walls 27 of the fixed housing 11, and a gap is also formed between the protrusion portion 32 and the movement restricting member 14. When the protrusion portion 32, which undergoes displacement together with the movable housing 12, undergoes displacement in the insertion direction X1, the protrusion portion 32 comes into contact with the partition walls 27, thus restricting the amount of displacement, in the insertion direction X1, of the movable housing 12 provided with the protrusion portion 32. Also, when the protrusion portion 32, which undergoes displacement together with the movable housing 12, undergoes displacement in the height direction X2, the protrusion portion 32 comes into contact with the movement restricting member 14, thus restricting the amount of displacement, in the height direction X2, of the movable housing 12 provided with the protrusion portion 32. Therefore, when the movable housing 12 inserted into the body portion 30 through the insertion opening 29 of the fixed housing 11 undergoes displacement in the height direction X2, which is the direction of withdrawal from the insertion opening 29, the protrusion portion 32 of the movable housing 12 comes into contact with the movement restricting member 14, thus restricting the amount of displacement of the movable housing 12 in the height direction X2, and preventing the movable housing 12 from coming out of the fixed housing 11.

As shown in FIGS. 1 to 8 and 10, the guide portion 31 is integrated with the body portion 30 on the height direction X2 end side of the body portion 30, and is provided as the end portion of the movable housing 12 on the height direction X2 side. The guide portion 31 is provided as the portion that guides the partner connection members 101a into the movable housing 12 when the partner connection members 101a are inserted into the movable housing 12. The guide portion 31 is provided with an opening 33 into which the partner connection members 101a are inserted. The opening 33 is open in the height direction X2, which is the direction opposite to the insertion direction X1 in which the partner connection members 101a are inserted into the guide portion 31, and is open wide along the width direction X3. The guide portion 31 is configured to guide the partner connection members 101a from the opening 33 into the movable housing 12.

Also, a plurality of insertion holes 34, into which the partner connection members 101a guided by the guide portion 31 are respectively inserted, are provided side by side inside the guide portion 31. The insertion holes 34 are provided side by side in one row along the width direction X3 inside the guide portion 31. Note that the arrangement direction of the insertion holes 34 in the movable housing 12 is the width direction X3 of the electrical connector 1. The insertion holes 34 are arranged side by side at equal intervals in the width direction X3. The pitch dimension, which is the interval at which the insertion holes 34 are arranged side by side at equal intervals in the width direction X3, is set to the same interval as that of the partner connection members 101a arranged side by side at equal intervals in the width direction X3 in the partner connector 101.

Furthermore, the insertion holes 34 are open facing the height direction X2 inside the opening 33 of the guide portion 31. The insertion holes 34 are each in communication, in the insertion direction X1, with the holding chambers 30a arranged side by side in the width direction X3 inside the body portion 30 of the movable housing 12. When the partner connection members 101a are inserted into the guide portion 31 of the movable housing 12, they are inserted into the guide portion 31 through the opening 33. The partner connection members 101a inserted through the opening 33 are respectively inserted into the insertion holes 34 that are arranged side by side in the width direction X3 inside the opening 33 and are open facing the height direction X2. When inserted into the insertion holes 34, the partner connection members 101a pass through the insertion holes 34 and are inserted into the holding chambers 30a (see FIGS. 7 and 8). When inserted into the holding chambers 30a, the partner connection members 101a come into contact with the partner connection portions 40 of the terminals 13 held in the holding chambers 30a. The partner connection members 101a inserted into the insertion holes 34 come into contact with the partner connection portions 40 of the terminals 13, and thus the partner connection members 101a are electrically connected to the terminals 13.

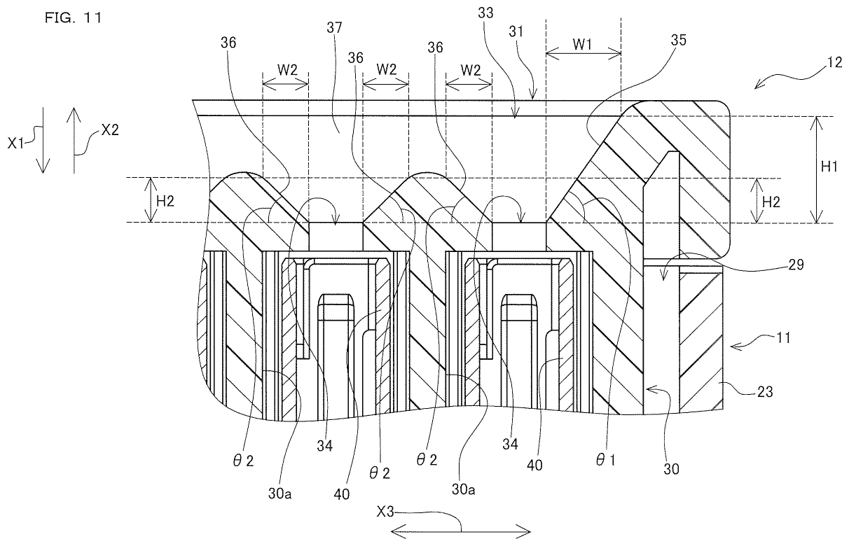

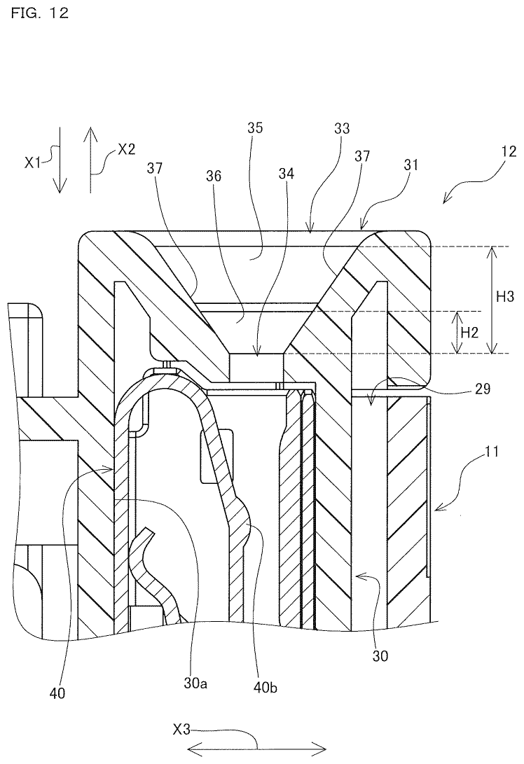

The configuration of the guide portion 31 will be described below in more detail. FIG. 11 is an enlarged view of a portion of FIG. 5B. FIG. 12 is an enlarged view of a portion of FIG. 6B. As shown in FIGS. 2, 4 to 8, and 10 to 12, the inner wall of the guide portion 31 is provided with first inclined surfaces 35 respectively at the two end sides in the width direction X3, which is the arrangement direction of the insertion holes 34. The first inclined surfaces 35 are inclined relative to the height direction X2 so as to widen in a tapered manner while extending in the height direction X2, which is the direction opposite to the insertion direction X1 in which the partner connection members 101a are inserted into the guide portion 31, and outward in the width direction X3 to the opening 33. The first inclined surfaces 35 are respectively provided at the two end sides of the inner wall of the guide portion 31 in the width direction X3, and the first inclined surfaces 35 at the two end sides in the width direction X3 are respectively continuous with the insertion holes 34 arranged at the two end sides in the width direction X3 among the insertion holes 34.

Also, as shown in FIGS. 2, 4 to 8, and 10 to 12, inside the guide portion 31, second inclined surfaces 36 are provided between each pair of insertion holes 34 adjacent to each other in the width direction X3. The second inclined surfaces 36 provided between insertion holes 34 adjacent in the width direction X3 are surfaces inclined relative to the height direction X2 so as to extend in a tapered manner while extending in the insertion direction X1 and toward the openings of the insertion holes 34 into which the partner connection members 101a are inserted. The two insertion holes 34 arranged at the ends in the width direction X3 each have an adjacent insertion hole 34 on only one side in the width direction X3, and therefore a corresponding inclined surface 36 is provided on only the one side in the width direction X3. The insertion holes 34 arranged at positions other than the two ends in the width direction X3 each have adjacent insertion holes 34 on both sides in the width direction X3, and therefore corresponding second inclined surfaces 36 are provided on both sides in the width direction X3. The second inclined surfaces 36 are provided so as to be continuous with the insertion holes 34. Also, between each pair of adjacent insertion holes 34, the second inclined surfaces 36 that are continuous with the adjacent insertion holes 34 are side by side in the width direction X3.

As shown in FIGS. 5B, 7, and 11, the dimension in the width direction X3 of the first inclined surfaces 35 provided at the two end sides of the inner wall of the guide portion 31 in the width direction X3 is set larger than the dimension in the width direction X3 of the second inclined surfaces 36 provided between adjacent insertion holes 34. Note that in FIG. 11, a dimension W1 of the first inclined surfaces 35 in the width direction X3 is indicated by a double-headed arrow W1, and a dimension W2 of the second inclined surfaces 36 in the width direction X3 is indicated by a double-headed arrow W2. The dimension W1 of the first inclined surfaces 35 in the width direction X3 is set larger than the dimension W2 of the second inclined surfaces 36 in the width direction X3.

Also, as shown in FIGS. 5B, 7, and 11, the dimension of the first inclined surfaces 35 in the height direction X2 is set larger than the dimension of the second inclined surfaces 36 in the height direction X2. Note that in FIG. 11, a dimension H1 of the first inclined surfaces 35 in the height direction X2 is indicated by a double-headed arrow H1, and a dimension H2 of the second inclined surfaces 36 in the height direction X2 is indicated by a double-headed arrow H2. The dimension H1 of the first inclined surfaces 35 in the height direction X2 is set larger than the dimension H2 of the second inclined surfaces 36 in the height direction X2.

Also, as shown in FIGS. 5B, 7, and 11, the magnitude of the smaller angle out of the angles formed by the width direction X3 and the inclination direction of each of the first inclined surfaces 35 relative to the height direction X2 is set larger than the magnitude of the smaller angle out of the angles formed by the width direction X3 and the inclination direction of each of the second inclined surfaces 36 relative to the height direction X2. Also, in FIG. 11, a smaller angle θ1 out of the angles formed by the width direction X3 and the inclination direction of each of the first inclined surfaces 35 relative to the height direction X2 is indicated by the symbol θ1. Also, in FIG. 11, a smaller angle θ2 out of the angles formed by the width direction X3 and the inclination direction of each of the second inclined surfaces 36 relative to the height direction X2 is indicated by the symbol θ2. The smaller angle θ1 out of the angles formed by the width direction X3 and the inclination direction of each of the first inclined surfaces 35 relative to the height direction X2 is the inclination angle of each of the first inclined surfaces 35 that widen in a tapered manner in the height direction X2 at the two end sides in the width direction X3 inside the guide portion 31. The smaller angle θ2 out of the angles formed by the width direction X3 and the inclination direction of each of the second inclined surfaces 36 relative to the height direction X2 is the inclination angle of each of the second inclined surfaces 36 that extend in a tapered manner toward the entrances of the insertion holes 34 between adjacent insertion holes 34. The angle θ1, which is the inclination angle of each of the first inclined surfaces 35, is set larger than the angle θ2, which is the inclination angle of each of the second inclined surfaces 36.

Also, as shown in FIGS. 2, 4 to 8, and 10 to 12, the inner wall of the guide portion 31 is provided with third inclined surfaces 37 respectively on two end sides in the front-rear direction X4, which is a direction perpendicular to the width direction X3 and the height direction X2. The third inclined surfaces 37 are inclined relative to the height direction X2 so as to widen in a tapered manner while extending in the height direction X2 and outward in the front-rear direction X4 to the opening 33. The third inclined surfaces 37 are respectively provided at the two end sides of the inner wall of the guide portion 31 in the front-rear direction X4, and are continuous with the insertion holes 34 arranged side by side in the width direction X3.

As shown in FIGS. 6B, 8, and 12, the dimension in the height direction X2 of the third inclined surfaces 37 provided at the two end sides of the inner wall of the guide portion 31 in the front-rear direction X4 is set larger than the dimension in the height direction X2 of the second inclined surfaces 36 provided between adjacent insertion holes 34. Also, in FIG. 12, a dimension H3 of the third inclined surfaces 37 in the height direction X2 is indicated by a double-headed arrow H3, and a dimension H2 of the second inclined surfaces 36 in the height direction X2 is indicated by a double-headed arrow H2. The dimension H3 of the third inclined surfaces 37 in the height direction X2 is set larger than the dimension H2 of the second inclined surfaces 36 in the height direction X2.

### Terminals

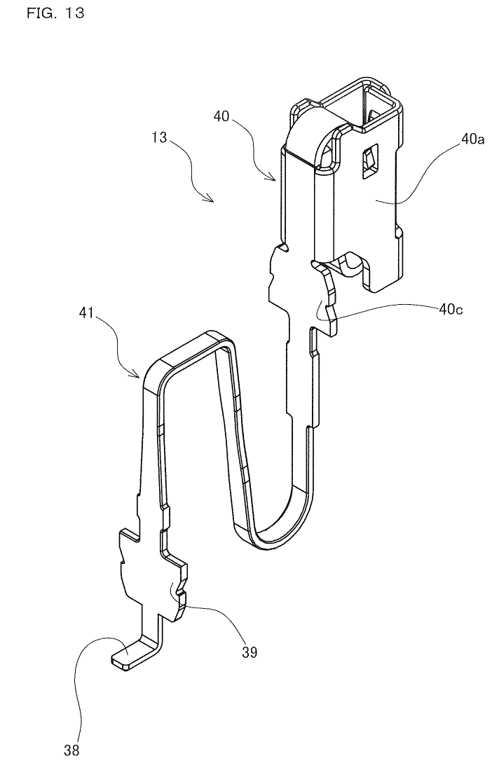

FIG. 13 is a perspective view of one of the terminals 13 of the electrical connector 1, and more specifically is an enlarged perspective view of one of the terminals 13 of the electrical connector 1. As shown in FIGS. 1 to 8 and 13, the electrical connector 1 is provided with the terminals 13, and the terminals 13 are arranged side by side in the width direction X3 in the electrical connector 1. Each of the terminals 13 is configured such that a first end portion on one side is fixed to the fixed housing 11, a second end portion on the other side is held by the movable housing 12, and the portion between the two end portions is elastically deformable. Accordingly, the terminals 13 are configured to support the movable housing 12 so as to be displaceable relative to the fixed housing 11. Also, the first end portions the terminals 13 are mounted and fixed to the substrate 100 by soldering, and the second end portions come into contact with and are electrically connected to the partner connection members 101a of the partner connector 101.

Also, each of the terminals 13 specifically includes a substrate connection portion 38, a fixing portion 39, a partner connection portion 40, and a movable spring portion 41. In the terminal 13, the substrate connection portion 38, the fixing portion 39, the movable spring portion 41, and the partner connection portion 40 are arranged side by side in this order and integrated with each other. The substrate connection portion 38 and the fixing portion 39 are provided at the first end portion of the terminal 13, and the partner connection portion 40 is provided at the second end portion of the terminal 13.

As shown in FIGS. 1 to 4, 6A, 6B, 8, and 13, the substrate connection portion 38 is the first end portion of the terminal 13, and is the portion that is connected to the substrate 100. The substrate connection portion 38 is electrically and mechanically connected to the substrate 100 by being fixed to the surface of the substrate 100 by soldering.

As shown in FIGS. 2 to 4, 6A, 6B, 8, and 11, the fixing portion 39 is the portion that is attached and fixed to the fixed housing 11, and is adjacent to the substrate connection portion 38 on the first end portion side of the terminals 13. The fixing portion 39 is fixed to the terminal holding wall 21 by being press-fitted into the terminal fixing portion 25 of the terminal holding wall 21 of the fixed housing 11. Note that the fixing portion 39 is provided with a pair of press-fit claw portions that project toward opposite sides in the width direction. When the fixing portion 39 is press-fitted into the terminal fixing portion 25, the pair of press-fitting claw portions of the fixing portion 39 are respectively inserted and press-fitted into a pair of press-fitting grooves of the terminal fixing portion 25. By the fixing portion 39 being press-fitted into the terminal fixing portion 25, the fixing portion 39 is fixed to the terminal fixing portion 25, and the terminal 13 is fixed to the terminal holding wall 21 of the fixed housing 11.

As shown in FIGS. 4 to 8 and 13, the partner connection portion 40 is the second end portion of the terminal 13, and is the portion that is held in the movable housing 12 is connected to the corresponding partner connection member 101a of the partner connector 101. The partner connection portion 40 is provided as a female terminal type of connection portion, and has a tubular portion 40a, a spring contact portion 40b, and a press-fitting portion 40c.

The tubular portion 40a of the partner connection portion 40 is a portion bent into a rectangular tubular shape. When the partner connection portion 40 is to be held by the movable housing 12, the tubular portion 40a is inserted into the holding chamber 30a of the body portion 30 of the movable housing 12 and held therein. The tubular portion 40a is open in the height direction X2, and when the tubular portion 40a is inserted into the holding chamber 30a, the opening of the tubular portion 40a faces the insertion hole 34. When connecting the terminal 13 to the partner connection member 101a, the partner connection member 101a inserted into the insertion hole 34 is inserted into the tubular portion 40a in the holding chamber 30a.

The spring contact portion 40b of the partner connection portion 40 is shaped as a leaf spring bent inside the tubular portion 40a, and has a contact portion that comes into contact with and is electrically connected to the partner connection member 101a. When connecting the terminal 13 to the partner connection member 101a, the spring contact portion 40b comes into contact with and is electrically connected to the partner connection member 101a that has been inserted into the insertion hole 34 of the movable housing 12 and inserted into the tubular portion 40a.

The press-fitting portion 40c of the partner connection portion 40 is adjacent to the tubular portion 40a, and is the portion that is press-fitted into the body portion 30 of the movable housing 12. When the tubular portion 40a is inserted into the holding chamber 30a of the body portion 30 of the movable housing 12, the press-fitting portion 40c is press-fitted against the inner wall of the holding chamber 30a. By the press-fitting portion 40c being press-fitted into the body portion 30, the partner connection portion 40 is firmly held against the body portion 30 of the movable housing 12.

As shown in FIGS. 2 to 4, 6A, 6B, 8, and 13, the movable spring portion 41 of the terminal 13 is a spring portion that integrally connects the fixing portion 39 and the partner connection portion 40 to each other and supports the partner connection portion 40 so as to be displaceable relative to the fixing portion 39. The movable spring portion 41 is an elongated leaf spring-like portion that extends while bending a plurality of times. In the present embodiment, the movable spring portion 41 extends in the height direction X2 from the fixing portion 39, then bends at a substantially right angle and extends toward the back wall 22 in the front-rear direction X4, then bends at a substantially right angle and extends in the insertion direction X1, then bends in a semicircular arc shape over approximately 180 degrees from the insertion direction X1 to the height direction X2 and extends, and is then connected to the partner connection portion 40.

Also, the movable spring portions 41 of the terminals 13 at positions other than the two ends in the width direction X3 in the electrical connector 1 are arranged so as to extend while bending a plurality of times between partition walls 27 adjacent to each other in the width direction X3 in the fixed housing 11. Furthermore, the movable spring portions 41 of the terminals 13 at the two ends in the width direction X3 in the electrical connector 1 are arranged so as to extend while bending a plurality of times between the side wall 23 and the partition walls 27 and between the side wall 24 and the partition walls 27 in the fixed housing 11.

### Connection Between Substrate and Partner Connector by Electrical Connector

Next, the connection between the substrate 100 and the partner connector 101 by the electrical connector 1 will be described. For example, a conductive circuit pattern (not shown) is provided on the surface of the substrate 100, and the electrical connector 1 is mounted on and connected to the substrate 100. When the electrical connector 1 is disposed on the substrate 100, the substrate connection portions 38 of the terminals 13 of the electrical connector 1 are soldered to the substrate 100, and the pair of fixing fittings 15 of the electrical connector 1 are also soldered to the substrate 100. The electrical connector 1 and the substrate 100 are thus connected to each other.

When the electrical connector 1 is connected to the substrate 100, the partner connector 101 is connected to the electrical connector 1. The substrate 100 and the partner connector 101 are thus electrically connected via the electrical connector 1. When connecting the partner connector 101 to the electrical connector 1, the partner connection members 101a of the partner connector 101 are inserted into the movable housing 12. First, the partner connection members 101a are inserted into the opening 33 of the guide portion 31 of the movable housing 12. The partner connection members 101a inserted into the opening 33 of the guide portion 31 are respectively inserted into the insertion holes 34 arranged side by side inside the guide portion 31. The partner connection members 101a inserted into the insertion holes 34 come into contact with the spring contact portions 40b of the partner connection portions 40 of the terminals 13 held inside the movable housing 12, and are electrically connected to the terminals 13. As a result, the electrical connector 1 and the partner connector 101 are connected to each other, and the substrate 100 and the partner connector 101 are electrically connected to each other via the electrical connector 1.

In the electrical connector 1, the movable housing 12 to which the partner connection members 101a of the partner connector 101 are connected is supported via the terminals 13 so as to be displaceable relative to the fixed housing 11 connected to the substrate 100. Therefore, even if positional deviation occurs between the substrate 100 and the partner connector 101, the positional deviation is absorbed by relative displacement between the movable housing 12 and the fixed housing 11. For example, even if vibration occurs in the substrate 100, the vibration generated in the substrate 100 is absorbed by elastic deformation of the movable spring portions 41 of the terminals 13 between the substrate 100 and the partner connector 101, thus suppressing the transmission of vibration to the partner connector 101.

### Operation of Connecting Partner Connection Member and Electrical Connector

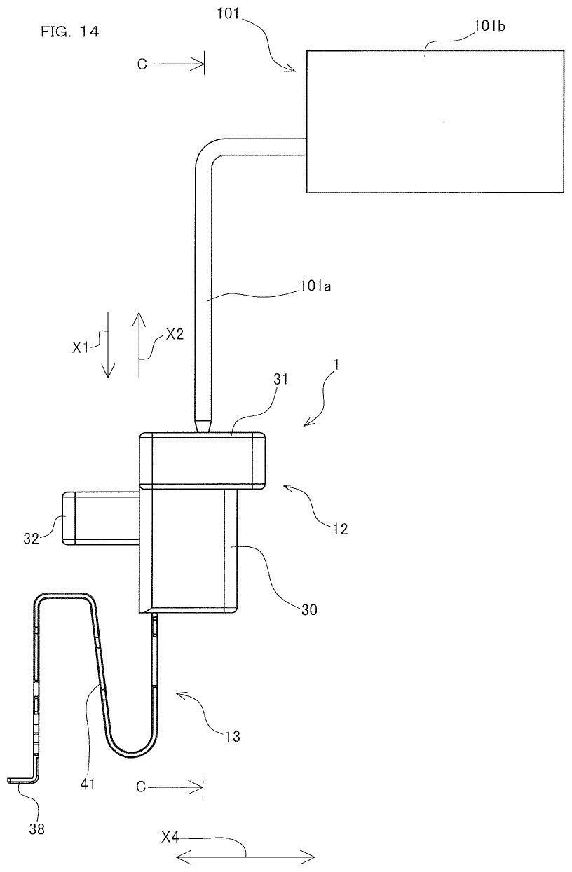

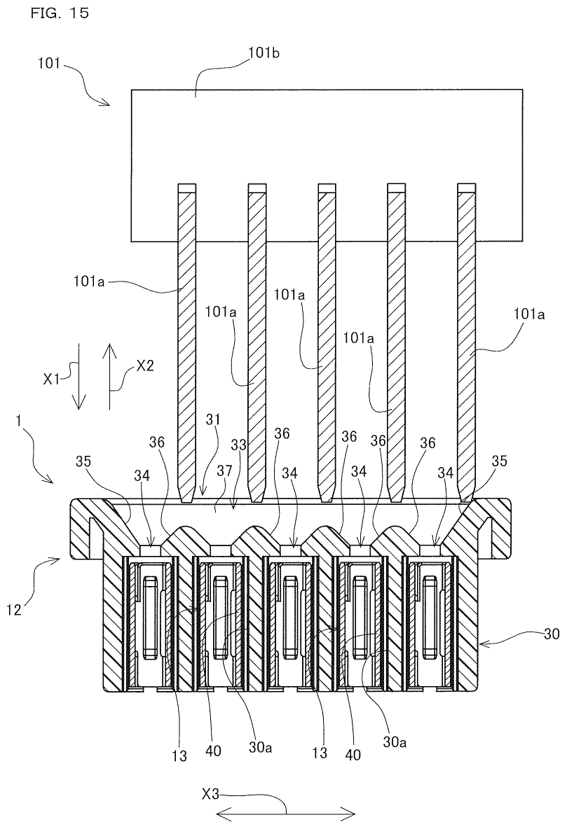

The following is a more detail description of operations when the pin-shaped partner connection members 101a arranged side by side in the partner connector 101 are inserted into and connected to the electrical connector 1. When inserting the partner connection members 101a into the electrical connector 1, the partner connection members 101a are inserted into the movable housing 12 of the electrical connector 1. At this time, there are cases where the partner connection members 101a are inserted into the movable housing 12 at deviated insertion positions. FIG. 14 is a side view illustrating a state immediately before the pin-shaped partner connection members 101a of the partner connector 101 are inserted into the electrical connector 1, with the fixed housing 11 being omitted from the electrical connector 1. FIG. 15 is a cross-sectional view taken along a line C-C in FIG. 14. FIGS. 14 and 15 show the case where the partner connection members 101a are inserted into the movable housing 12 at insertion positions deviated in the width direction X3.

As shown in FIGS. 14 and 15, when inserting the partner connection members 101a into the movable housing 12, the partner connection members 101a are inserted into the opening 33 of the guide portion 31 of the movable housing 12. In the case where the partner connection members 101a are inserted into the movable housing 12 at insertion positions deviated in the width direction X3, the partner connection members 101a are inserted into the opening 33 at positions deviated in the width direction X3 so as to not overlap the insertion holes 34 in the insertion direction X1. When the partner connection members 101a inserted into the opening 33 of the guide portion 31 are inserted into the opening 33 at insertion positions deviated in the width direction X3, the leading end portion of the partner connection member 101a at one of the two end sides in the width direction X3 among the partner connection members 101a comes into contact with the first inclined surface 35 at the corresponding one of the two end sides in the width direction X3 of the inner wall of the guide portion 31. Note that the dimension H1 of the first inclined surfaces 35 in the height direction X2 is set larger than the dimension H2 of the second inclined surfaces 36 in the height direction X2, and furthermore, the dimension W1 of the first inclined surfaces 35 in the width direction X3 is set larger than the dimension W2 of the second inclined surfaces 36 in the width direction X3. Therefore, if the partner connection members 101a arranged side by side are inserted into the opening 33 of the guide portion 31 at positions deviated in the width direction X3, before the leading end portions of the partner connection members 101a come into contact with the second inclined surfaces 36 leading to the insertion holes 34, the leading end portion of the partner connection member 101a at one of the two end sides in the width direction X3 among the partner connection members 101a comes into contact with the first inclined surface 35 at the corresponding one of the two end sides in the width direction X3 of the inner wall of the guide portion 31.

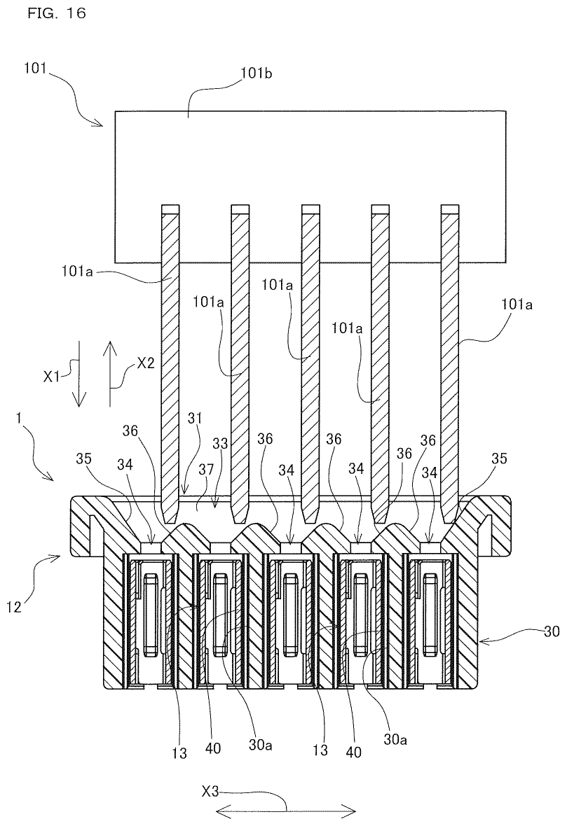

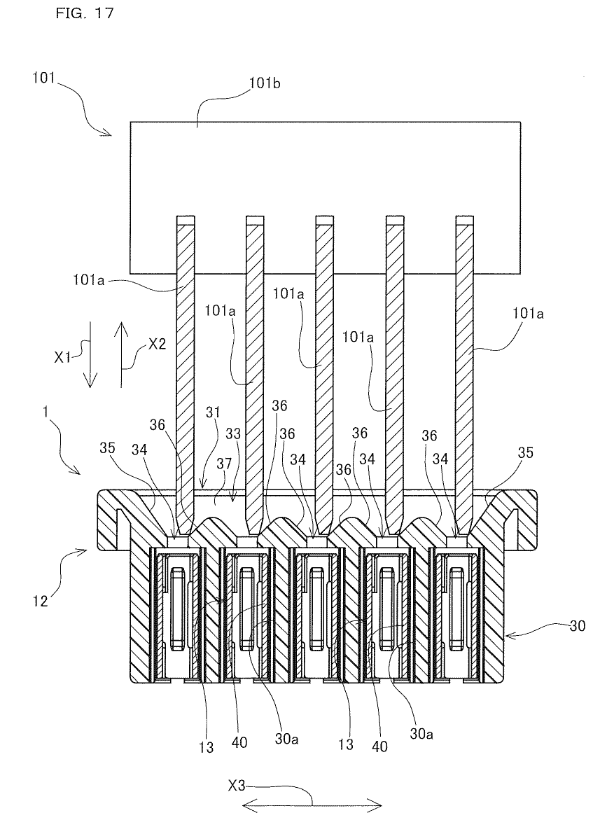

FIGS. 16 and 17 are cross-sectional views showing a state in which the pin-shaped partner connection members 101a of the partner connector 101 are being inserted into the electrical connector 1, the cross sections being taken at a position corresponding to the line C-C in FIG. 14. Note that FIG. 16 is a diagram showing a state in which the partner connection members 101a are inserted deeper into the guide portion 31 from the state shown in FIG. 15, and FIG. 17 is a diagram showing a state in which the partner connection members 101a are inserted even deeper into the guide portion 31 from the state shown in FIG. 16. As shown in FIG. 16, when the partner connection members 101a are inserted into the opening 33 and the partner connection member 101a at one of the two end sides in the width direction X3 comes into contact with the corresponding first inclined surface 35, that partner connection member 101a at the one of the two end sides in the width direction X3 slides along the corresponding first inclined surface 35 while being inserted into the opening 33. Accordingly, the partner connection members 101a arranged side by side move in the insertion direction X1 together with the partner connection member 101a at the one of the two end sides in the width direction X3 that slides along the corresponding first inclined surface 35 while being inserted into the opening 33. Therefore, the partner connection members 101a arranged side by side are guided by the first inclined surface 35 while being inserted into the guide portion 31. As shown in FIG. 17, the partner connection members 101a are guided by the first inclined surface 35 while being inserted deeper into the guide portion 31, and are then guided to the corresponding insertion holes 34. Upon being guided to the insertion holes 34, the partner connection members 101a are then respectively inserted into the insertion holes 34. The partner connection members 101a inserted into the insertion holes 34 pass through the insertion holes 34, come into contact with the spring contact portions 40b of the partner connection portions 40 of the terminals 13 held inside the movable housing 12, and are electrically connected to the terminals 13 (see FIG. 7).

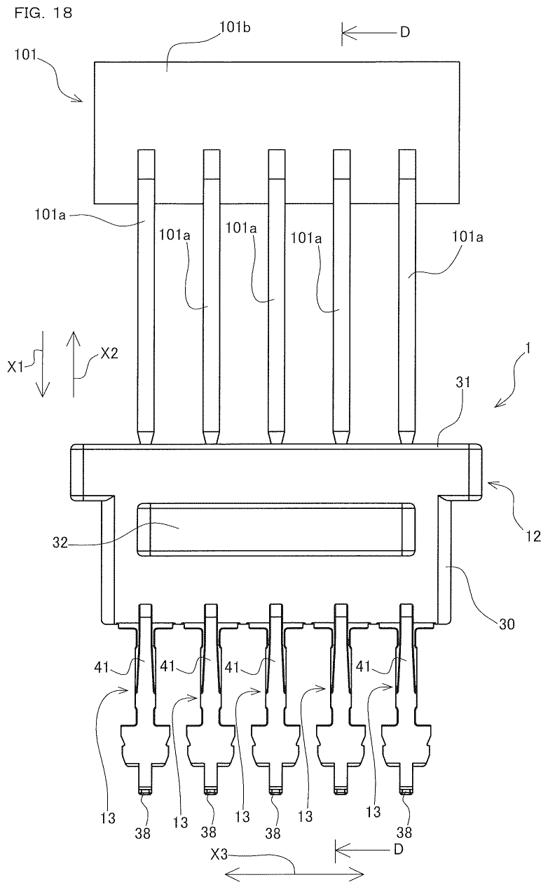

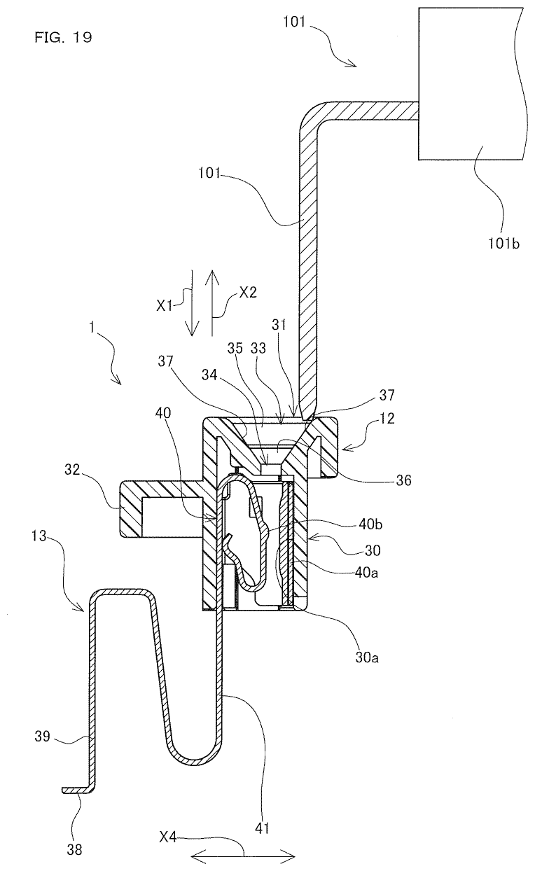

Next, a case will be described in which the partner connection members 101a are inserted into the movable housing 12 at insertion positions deviated in the front-rear direction X4. FIG. 18 is a front view illustrating a state immediately before the pin-shaped partner connection members 101a of the partner connector 101 are inserted into the electrical connector 1, with the fixed housing 11 being omitted from the electrical connector 1. FIG. 19 is a cross-sectional view taken along a line D-D in FIG. 18. FIGS. 18 and 19 show the case where the partner connection members 101a are inserted into the movable housing 12 at insertion positions deviated in the front-rear direction X4.

As shown in FIGS. 18 and 19, when inserting the partner connection members 101a into the movable housing 12, the partner connection members 101a are inserted into the opening 33 of the guide portion 31 of the movable housing 12. In the case where the partner connection members 101a are inserted into the movable housing 12 at insertion positions deviated in the front-rear direction X4, the partner connection members 101a are inserted into the opening 33 at positions deviated in the front-rear direction X4 so as to not overlap the insertion holes 34 in the insertion direction X1. When the partner connection members 101a inserted into the opening 33 of the guide portion 31 are inserted into the opening 33 at insertion positions deviated in the front-rear direction X4, the leading end portions of the partner connection members 101a come into contact with the third inclined surface 37 at one of the two end sides in the front-rear direction X4 of the inner wall the guide portion 31. Note that the dimension H1 of the third inclined surfaces 37 in the height direction X2 is set larger than the dimension H2 of the second inclined surfaces 36 in the height direction X2. Therefore, if the partner connection members 101a arranged side by side are inserted into the opening 33 of the guide portion 31 at positions deviated in the front-rear direction X4, before the leading end portions of the partner connection members 101a reach the same height as the second inclined surfaces 36 leading to the insertion holes 34, the leading end portions of the partner connection members 101a come into contact with the third inclined surface 37 at one of the two end sides in the front-rear direction X4 of the inner wall the guide portion 31.

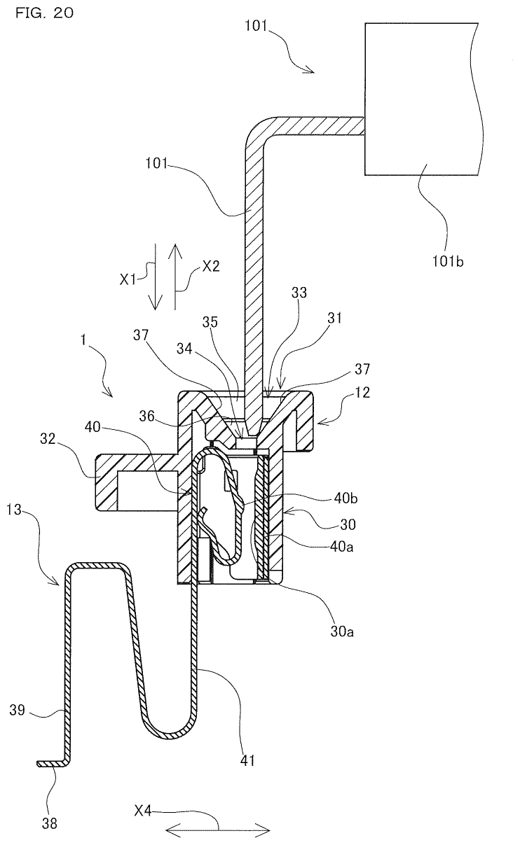

FIG. 20 is a cross-sectional view illustrating a state in which the pin-shaped partner connection members 101a of the partner connector 101 are being inserted into the electrical connector 1, the cross section being taken at a position corresponding to the line D-D in FIG. 18. As shown in FIG. 20, when the partner connection members 101a are inserted into the opening 33 and the partner connection members 101a come into contact with the third inclined surface 37 at one of the two end sides in the front-rear direction X4, the partner connection members 101a slide along the corresponding third inclined surface 37 while being inserted into the opening 33. Accordingly, the partner connection members 101a arranged side by side slide along the third inclined surface 37 while moving in the insertion direction X1. Therefore, the partner connection members 101a arranged side by side are guided by the third inclined surface 37 while being inserted into the guide portion 31. Then, the partner connection members 101a are guided by the third inclined surface 37 while being inserted deeper into the guide portion 31, and are then guided to the corresponding insertion holes 34. Upon being guided to the insertion holes 34, the partner connection members 101a are then respectively inserted into the insertion holes 34. The partner connection members 101a inserted into the insertion holes 34 pass through the insertion holes 34, come into contact with the spring contact portions 40b of the partner connection portions 40 of the terminals 13 held inside the movable housing 12, and are electrically connected to the terminals 13 (see FIG. 8).

Actions and Effects of First Embodiment According to the first embodiment, when connecting the electrical connector 1 to the pin-shaped partner connection members 101a arranged side by side, the partner connection members 101a are inserted into the opening 33 of the guide portion 31 of the movable housing 12. If the partner connection members 101a inserted into the opening 33 of the guide portion 31 of the movable housing 12 are inserted into the opening 33 without deviation in the insertion positions, the partner connection members 101a are respectively inserted into the insertion holes 34 inside the guide portion 31. The partner connection members 101a inserted into the insertion holes 34 are respectively electrically connected to the terminals 13. However, if the partner connection members 101a inserted into the opening 33 of the guide portion 31 of the movable housing 12 are inserted into the opening 33 at insertion positions deviated in the width direction X3, the leading end portion of the partner connection member 101a at one of the two end sides in the width direction X3 among the partner connection members 101a comes into contact with the first inclined surface 35 at one of the two end sides in the width direction X3 of the inner wall of the guide portion 31. Note that the first inclined surfaces 35, which are inclined so as to extend in the height direction X2 and outward in the width direction X3 at the two end sides in the width direction X3 of the inner wall of the guide portion 31, have a larger dimension in the height direction X2 and dimension in the width direction X3 than the second inclined surfaces 36, which are inclined toward the entrances of the insertion holes 34 between adjacent insertion holes 34. Therefore, if the partner connection members 101a arranged side by side are inserted into the opening 33 of the guide portion 31 at positions deviated in the width direction X3, before the leading end portions of the partner connection members 101a come into contact with the second inclined surfaces 36 leading to the insertion holes 34, the leading end portion of the partner connection member 101a at one of the two end sides in the width direction X3 among the partner connection members 101a comes into contact with the first inclined surface 35 at the corresponding one of the two end sides in the width direction X3 of the inner wall of the guide portion 31. Then, the partner connection member 101a at one of the two end sides in the width direction X3 slides along the corresponding first inclined surface 35 while being inserted into the opening 33. Accordingly, the partner connection members 101a arranged side by side move together with the partner connection member 101a at the one of the two end sides in the width direction X3 that slides along the corresponding first inclined surface 35 while being inserted into the opening 33, and are guided by the first inclined surface 35 while being inserted into the guide portion 31. The partner connection members 101a are guided along the inclination direction of the first inclined surface 35 while being inserted into the guide portion 31, and are then respectively inserted into the insertion holes 34. Therefore, even if the partner connection members 101a are inserted into the movable housing 12 at insertion positions deviated in the width direction X3, the partner connection members 101a are guided along the inclination direction of the first inclined surface 35 while being inserted into the guide portion 31, and are appropriately inserted into the insertion holes 34. Therefore, the operation for inserting the pin-shaped partner connection members 101a arranged side by side into the electrical connector 1 for connection thereto can be performed appropriately and easily. Also, according to the first embodiment, with a simple structure in which the movable housing 12 is provided with the first inclined surfaces 35 at the two end sides in the width direction X3 of the guide portion 31 provided with the opening 33, the operation for inserting the pin-shaped partner connection members 101a arranged side by side into the electrical connector 1 for connection thereto can be performed appropriately and easily. Therefore, it is possible to suppress an increase in the size and the complexity of the structures of the electrical connector 1 and the partner connector 101 connected to the electrical connector 1.

As described above, according to the first embodiment, it is possible to provide the electrical connector 1 that enables appropriately and easily performing the operation of inserting and connecting the pin-shaped partner connection members 101a arranged side by side, and enables suppressing an increase in the size and the complexity of the structure.

Also, in the case where the magnitude of the smaller angle θ1 out of the angles formed by the width direction X3 and the inclination direction of each of the first inclined surfaces 35 relative to the height direction X2 is the same as the magnitude of the smaller angle θ2 out of the angles formed by the width direction X3 and the inclination direction of each of the second inclined surfaces 36 relative to the height direction X2, when the partner connection members 101a are guided along the inclination direction of one of the first inclined surfaces 35 while being inserted into the guide portion 31 and then reach the same height position as the second inclined surfaces 36, the partner connection members 101a are then guided along both the one first inclined surface 35 and the second inclined surfaces 36 and respectively inserted into the insertion holes 34. In contrast, according to the first embodiment, the smaller angle θ1 out of the angles formed by the width direction X3 and the inclination direction of each of the first inclined surfaces 35 relative to the height direction X2 is set larger than the smaller angle θ2 out of the angles formed by the width direction X3 and the inclination direction of each of the second inclined surfaces 36 relative to the height direction X2. Accordingly, even when the partner connection members 101a are guided along the inclination direction of one of the first inclined surfaces 35 while being inserted into the guide portion 31 and then reach the same height position as the second inclined surfaces 36, the partner connection members 101a are then guided along the one first inclined surface 35 and respectively inserted into the insertion holes 34 substantially without sliding along the second inclined surfaces 36. In this way, the partner connection members 101a inserted into the opening 33 of the movable housing 12 are guided along the one first inclined surface 35 and respectively inserted into the insertion holes 34 substantially without sliding along the second inclined surfaces 36. Therefore, the operation of appropriately inserting and connecting the pin-shaped partner connection members 101a arranged side by side can be performed even more smoothly and easily.

Also, according to the first embodiment, in the case where the partner connection members 101a inserted into the opening 33 of the guide portion 31 of the movable housing 12 are inserted into the opening 33 at insertion positions deviated in the front-rear direction X4, the leading end portions of the partner connection members 101a come into contact with the third inclined surface 37 at one of the two end sides in the front-rear direction X4 of the inner wall of the guide portion 31. Note that the third inclined surfaces 37, which are inclined so as to extend in the height direction X2 and outward in the front-rear direction X4 at the two end sides in the front-rear direction X4 of the inner wall of the guide portion 31, have a larger dimension in the height direction X2 than the second inclined surfaces 36, which are inclined toward the entrances of the insertion holes 34 between adjacent insertion holes 34. Therefore, if the partner connection members 101a arranged side by side are inserted into the opening 33 of the guide portion 31 at positions deviated in the front-rear direction X4, before the leading end portions of the partner connection members 101a reach the same height as the second inclined surfaces 36 leading to the insertion holes 34, the leading end portions of the partner connection members 101a come into contact with the third inclined surface 37 at one of the two end sides in the front-rear direction X4 of the inner wall the guide portion 31. The partner connection members 101a arranged side by side then slide along the third inclined surface 37 while being inserted into the opening 33, and are guided by the third inclined surface 37 while being inserted into the guide portion 31. The partner connection members 101a are guided along the inclination direction of the third inclined surface 37 while being inserted into the guide portion 31, and are then respectively inserted into the insertion holes 34. Therefore, even if the partner connection members 101a are inserted into the movable housing 12 at insertion positions deviated in the front-rear direction X4, the partner connection members 101a are guided along the inclination direction of the third inclined surface 37 while being inserted into the guide portion 31, and are appropriately inserted into the insertion holes 34. Therefore, the operation for inserting the pin-shaped partner connection members 101a arranged side by side into the electrical connector 1 for connection thereto can be performed appropriately and easily.

### Second Embodiment

Next, an electrical connector 2 according to a second embodiment of the present invention will be described. Note that in the following description of the second embodiment, elements having configurations similar to those in the first embodiment described above and elements having configurations corresponding to those in the first embodiment are denoted by the same reference numerals in the drawings referred to by the same reference numerals in order to omit redundant descriptions.

In the first embodiment described above, in the electrical connector 1, the terminals 13 are arranged side by side in one row along the width direction X3, and the pin-shaped partner connection members 101a arranged side by side in one row are connected to the electrical connector 1 by insertion therein. However, unlike the electrical connector 1 of the first embodiment, in the electrical connector 2 of the second embodiment, the terminals 13 are arranged side by side in two rows along the width direction X3, and the pin-shaped partner connection members 101a are arranged side by side in two rows and connected to the electrical connector 2 by insertion therein.

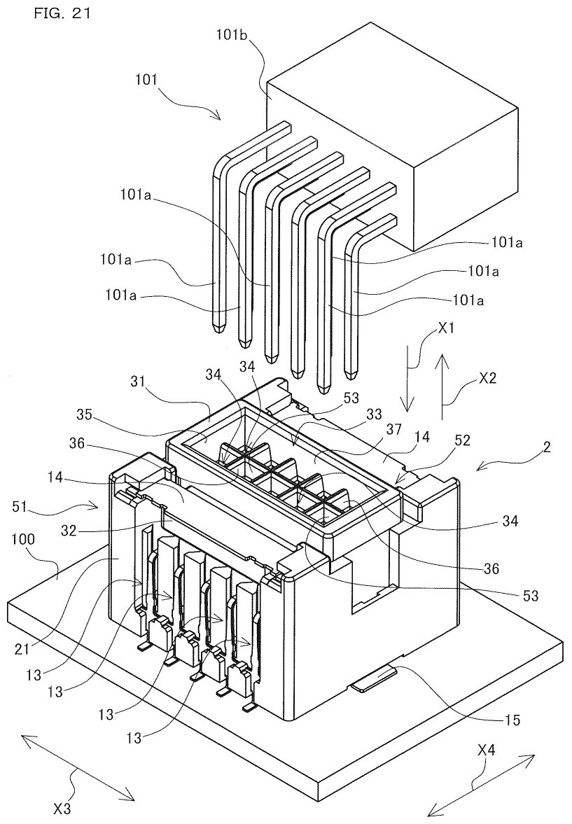

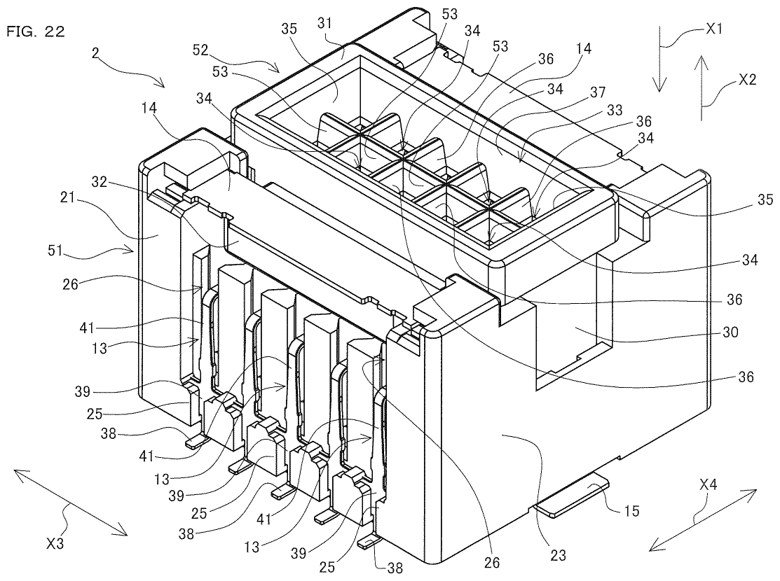

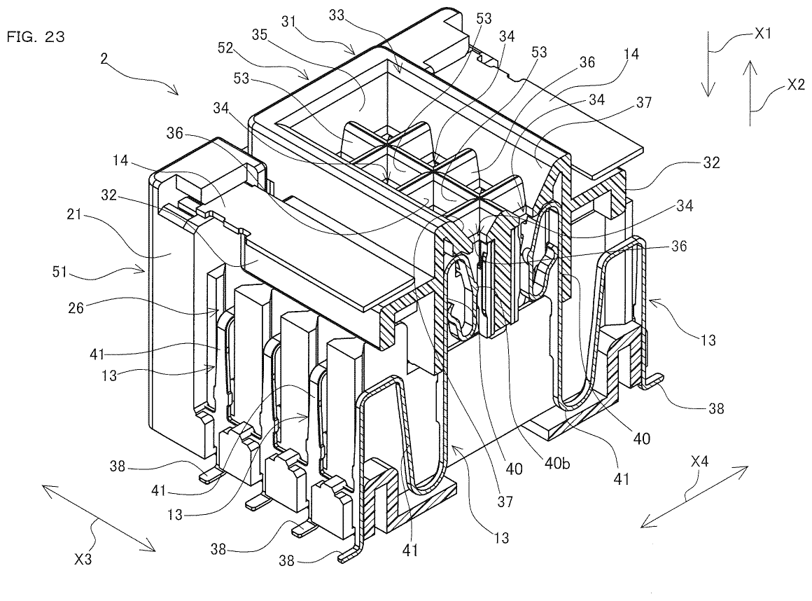

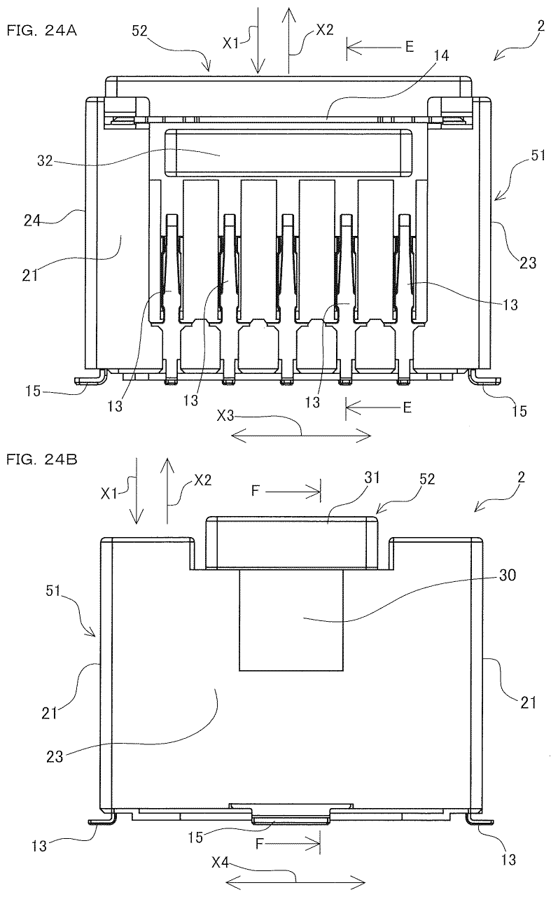

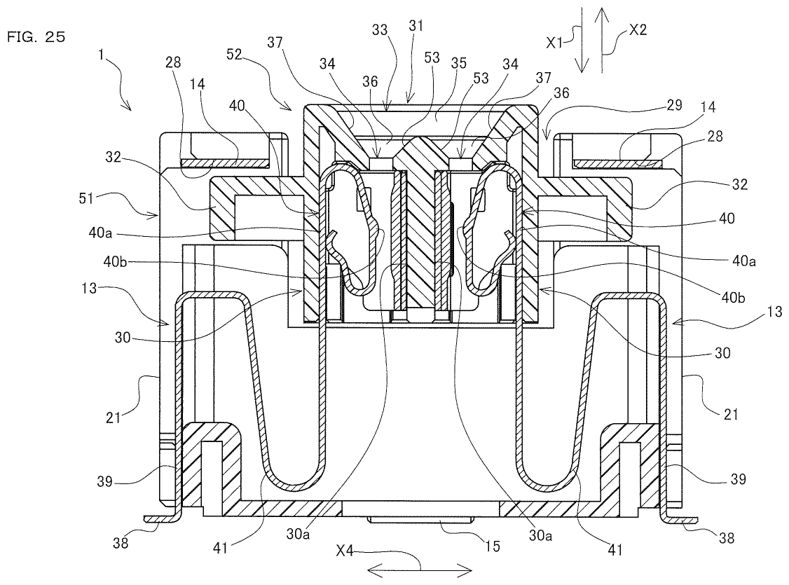

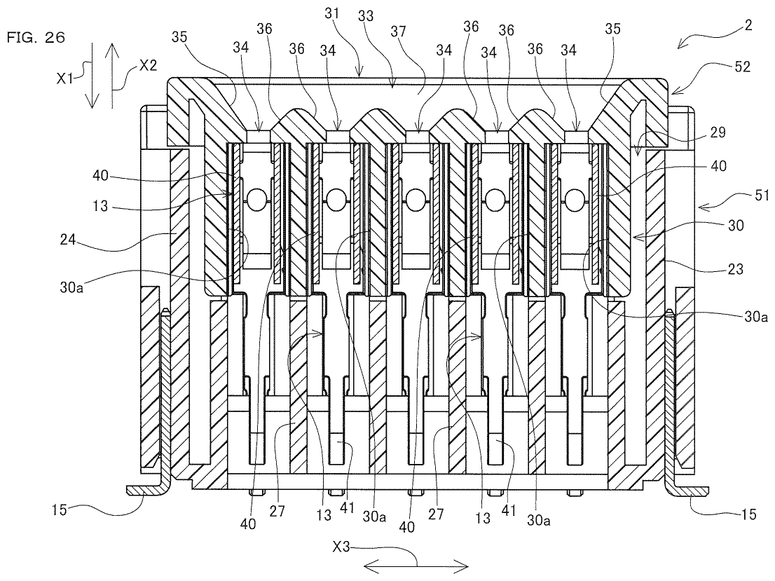

FIG. 21 is a perspective view of the electrical connector 2 according to the second embodiment together with the substrate 100 and the partner connector 101. FIG. 22 is a perspective view of the electrical connector 2. FIG. 23 is a perspective view of the electrical connector 2 and includes a cross section taken along a plane perpendicular to the width direction X3 of the electrical connector 2. FIG. 24A is a front view of the electrical connector 2, and FIG. 24B is a side view of the electrical connector 2. FIG. 25 is a cross-sectional view taken along a line E-E in FIG. 24A. FIG. 26 is a cross-sectional view taken along a line F-F in FIG. 24B.

As shown in FIGS. 21 to 26, the electrical connector 2 according to the second embodiment is configured as an electrical connector that is to be electrically connected to the partner connector 101 having the pin-shaped partner connection members 101a arranged side by side in two rows. The electrical connector 2 is configured as an electrical connector to which the pin-shaped partner connection members 101a arranged side by side in two rows in the partner connector 101 are connected by being inserted therein.

Similarly to the electrical connector 1 of the first embodiment, the electrical connector 2 according to the second embodiment includes a fixed housing 51 to be disposed on the substrate 100, a movable housing 52 to be mounted so as to be displaceable relative to the fixed housing 51, and the terminals 13 that support the movable housing 52 so as to be displaceable relative to the fixed housing 51, and are configured to be respectively electrically connected to the pin-shaped partner connection members 101a. However, given that the terminals 13 are arranged side by side in two rows along the width direction X3, and that the pin-shaped partner connection members 101a arranged side by side in two rows are connected to the electrical connector 2 by insertion therein, the configurations of the fixed housing 51 and the movable housing 52 are partially different from those in the electrical connector 1 of the first embodiment described above.

Note that in the following description of the electrical connector 2, the insertion direction X1, the height direction X2, the width direction X3, and the front-rear direction X4 of the electrical connector 2 are respectively defined as shown by an arrow X1, an arrow X2, a double-headed arrow X3, and a double-headed arrow X4 in FIGS. 21 to 26 and later-described drawings. The insertion direction X1 is a direction in which the pin-shaped partner connection members 101a are inserted into and connected to the movable housing 52 in the electrical connector 2. The pin-shaped partner connection members 101a are inserted into the movable housing 52 via the guide portion 31 of the movable housing 52. The insertion direction X1 is also the direction in which the movable housing 52 is inserted into and mounted to the fixed housing 51. The height direction X2 is a direction opposite to the insertion direction X1. In other words, the height direction X2 is parallel with and opposite to the insertion direction X1, and is opposite to the direction in which the partner connection members 101a are inserted into the movable housing 52. The width direction X3 is the arrangement direction of insertion holes 34 that are arranged side by side in two rows inside the guide portion 31 of the movable housing 52. The partner connection members 101a arranged side by side in two rows are respectively inserted into the insertion holes 34 arranged side by side in two rows. Note that the width direction X3, which is the arrangement direction of the insertion holes 34 arranged side by side in two rows inside the guide portion 31 of the movable housing 52, is also the pitch direction of the terminals 13 arranged side by side in two rows in the fixed housing 51. The front-rear direction X4 is a direction perpendicular to both the height direction X2 and the width direction X3. In other words, the front-rear direction X4 is a direction that is perpendicular to the height direction X2 and the insertion direction X1 and also perpendicular to the width direction X3.

As shown in FIGS. 21 to 26, the fixed housing 51, which is to be disposed on the substrate 100, has a configuration substantially similar to the fixed housing 11 of the electrical connector 1, but unlike the fixed housing 11, the back wall 22 is not provided, and a pair of terminal holding walls 21 are provided. Specifically, the fixed housing 51 includes a pair of terminal holding walls 21 that are arranged so as to face each other in the front-rear direction X4 and extend parallel with each other, and a pair of side walls 23 and 24 that extend perpendicularly to the pair of terminal holding walls 21. One terminal holding wall 21 out of the pair of terminal holding walls 21 is a wall portion that holds the terminals 13 in one row among the terminals 13 arranged side by side in two rows along the width direction X3. The other terminal holding wall 21 out of the pair of terminal holding walls 21 is a wall portion that holds the terminals 13 in the other row among the terminals 13 arranged side by side in two rows along the width direction X3.

The movable housing 52, which is to be mounted so as to be displaceable relative to the fixed housing 51, has a configuration substantially similar to the movable housing 12 of the electrical connector 1, but unlike the movable housing 12, the partner connection members 101a arranged side by side in two rows are connected to the body portion 30 and the guide portion 31 by being inserted therein.

In the body portion 30 of the movable housing 52, a plurality of holding chambers 30a are arranged side by side in two rows along the width direction X3. In the body portion 30 of the movable housing 52, the rows of holding chambers 30a among the holding chambers 30a arranged side by side in two rows are respectively provided in correspondence with the rows of insertion holes 34 arranged side by side in two rows in the guide portion 31. Furthermore, the holding chambers 30a in one row among the holding chambers 30a arranged side by side in two rows in the body portion 30 of the movable housing 52 hold the partner connection portions 40 of the terminals 13 in one row among the terminals 13 arranged side by side in two rows in the electrical connector 2. The holding chambers 30a in the other row among the holding chambers 30a arranged side by side in two rows in the body portion 30 of the movable housing 52 hold the partner connection portions 40 of the terminals 13 in the other row among the terminals 13 arranged side by side in two rows in the electrical connector 2.

As shown in FIGS. 21 to 26, the guide portion 31 of the movable housing 52 is integrated with the body portion 30 on the height direction X2 end side of the body portion 30, and is provided as the end portion of the movable housing 52 on the height direction X2 side. The guide portion 31 is provided as the portion that guides the partner connection members 101a into the movable housing 12 when the partner connection members 101a are inserted into the movable housing 12. The guide portion 31 includes an opening 33 into which the partner connection members 101a are inserted. The opening 33 is open in the height direction X2, which is the direction opposite to the insertion direction X1 in which the partner connection members 101a are inserted into the guide portion 31, and is open wide along the width direction X3. The guide portion 31 is configured to guide the partner connection members 101a from the opening 33 into the movable housing 12.

Also, a plurality of insertion holes 34, into which the partner connection members 101a guided by the guide portion 31 are respectively inserted, are provided side by side in two rows inside the guide portion 31. The insertion holes 34 are provided side by side in two rows along the width direction X3 inside the guide portion 31. Note that the arrangement direction of the insertion holes 34 side by side in two rows in the movable housing 52 is the width direction X3 of the electrical connector 2. The insertion holes 34 are arranged side by side in two rows at equal intervals in the width direction X3. The pitch dimension, which is the interval at which the insertion holes 34 are arranged side by side in two rows at equal intervals in the width direction X3, is set to the same interval as that of the partner connection members 101a arranged side by side in two rows at equal intervals in the width direction X3 in the partner connector 101.

Furthermore, the insertion holes 34 are open facing the height direction X2 inside the opening 33 of the guide portion 31. The insertion holes 34 are each in communication, in the insertion direction X1, with the holding chambers 30a arranged side by side in two rows in the width direction X3 inside the body portion 30 of the movable housing 52. When the partner connection members 101a are inserted into the guide portion 31 of the movable housing 52, they are inserted into the guide portion 31 through the opening 33. The partner connection members 101a inserted through the opening 33 are respectively inserted into the insertion holes 34 that are arranged side by side in two rows in the width direction X3 inside the opening 33 and are open facing the height direction X2. When inserted into the insertion holes 34, the partner connection members 101a pass through the insertion holes 34 and are inserted into the holding chambers 30a. When inserted into the holding chambers 30a, the partner connection members 101a come into contact with the partner connection portions 40 of the terminals 13 held in the holding chambers 30a. The partner connection members 101a inserted into the insertion holes 34 come into contact with the partner connection portions 40 of the terminals 13, and thus the partner connection members 101a are electrically connected to the terminals 13.

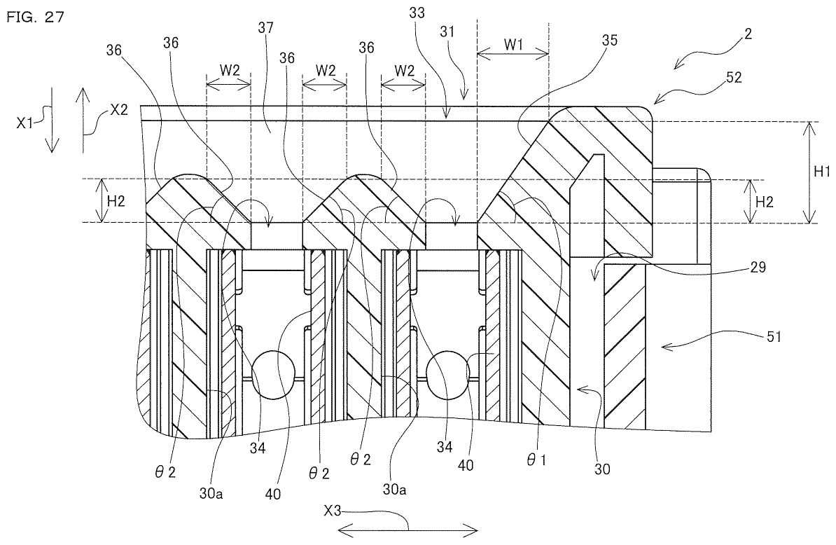

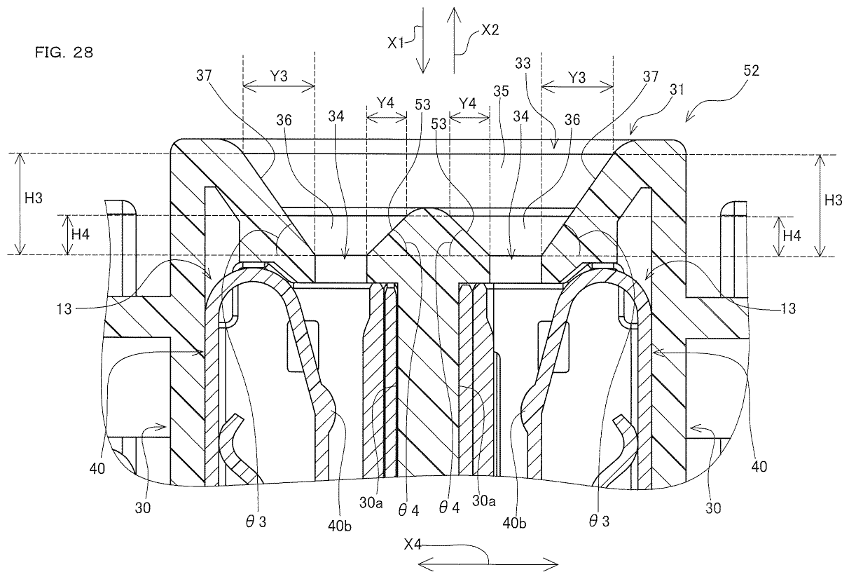

The configuration of the guide portion 31 of the movable housing 52 will be described below in more detail. FIG. 27 is an enlarged view of a portion of FIG. 26. FIG. 28 is an enlarged view of a portion of FIG. 25. As shown in FIGS. 21 to 23, 26, and 27, the inner wall of the guide portion 31 is provided with first inclined surfaces 35 respectively at the two end sides in the width direction X3, which is the arrangement direction of the insertion holes 34 side by side in two rows. The first inclined surfaces 35 are inclined relative to the height direction X2 so as to widen in a tapered manner while extending in the height direction X2, which is the direction opposite to the insertion direction X1 in which the partner connection members 101a are inserted into the guide portion 31, and outward in the width direction X3 to the opening 33. The first inclined surfaces 35 are respectively provided at the two end sides of the inner wall of the guide portion 31 in the width direction X3, and the first inclined surfaces 35 at the two end sides in the width direction X3 are respectively continuous with the insertion holes 34 arranged at the two end sides in the width direction X3 among the insertion holes 34.

Also, as shown in FIGS. 21 to 23, 26, and 27, inside the guide portion 31, second inclined surfaces 36 are provided between each pair of insertion holes 34 adjacent to each other in the width direction X3. The second inclined surfaces 36 provided between insertion holes 34 adjacent in the width direction X3 are surfaces inclined relative to the height direction X2 so as to extend in a tapered manner while extending in the insertion direction X1 and toward the openings of the insertion holes 34 into which the partner connection members 101a are inserted. The two insertion holes 34 arranged at the ends in the width direction X3 each have an adjacent insertion hole 34 on only one side in the width direction X3, and therefore a corresponding inclined surface 36 is provided on only the one side in the width direction X3. The insertion holes 34 arranged at positions other than the two ends in the width direction X3 each have adjacent insertion holes 34 on both sides in the width direction X3, and therefore corresponding second inclined surfaces 36 are provided on both sides in the width direction X3. The second inclined surfaces 36 are provided so as to be continuous with the insertion holes 34. Also, between each pair of adjacent insertion holes 34, the second inclined surfaces 36 that are continuous with the adjacent insertion holes 34 are side by side in the width direction X3.

As shown in FIGS. 26 and 27, the dimension in the width direction X3 of the first inclined surfaces 35 provided at the two end sides of the inner wall of the guide portion 31 in the width direction X3 is set larger than the dimension in the width direction X3 of the second inclined surfaces 36 provided between adjacent insertion holes 34. Note that in FIG. 27, a dimension W1 of the first inclined surfaces 35 in the width direction X3 is indicated by a double-headed arrow W1, and a dimension W2 of the second inclined surfaces 36 in the width direction X3 is indicated by a double-headed arrow W2. The dimension W1 of the first inclined surfaces 35 in the width direction X3 is set larger than the dimension W2 of the second inclined surfaces 36 in the width direction X3.

Also, as shown in FIGS. 26 and 27, the dimension of the first inclined surfaces 35 in the height direction X2 is set larger than the dimension of the second inclined surfaces 36 in the height direction X2. Note that in FIG. 11, a dimension H1 of the first inclined surfaces 35 in the height direction X2 is indicated by a double-headed arrow H1, and a dimension H2 of the second inclined surfaces 36 in the height direction X2 is indicated by a double-headed arrow H2. The dimension H1 of the first inclined surfaces 35 in the height direction X2 is set larger than the dimension H2 of the second inclined surfaces 36 in the height direction X2.

Also, as shown in FIGS. 26 and 27, the magnitude of the smaller angle out of the angles formed by the width direction X3 and the inclination direction of each of the first inclined surfaces 35 relative to the height direction X2 is set larger than the magnitude of the smaller angle out of the angles formed by the width direction X3 and the inclination direction of each of the second inclined surfaces 36 relative to the height direction X2. Also, in FIG. 27, a smaller angle θ1 out of the angles formed by the width direction X3 and the inclination direction of each of the first inclined surfaces 35 relative to the height direction X2 is indicated by the symbol θ1. Also, in FIG. 27, a smaller angle θ2 out of the angles formed by the width direction X3 and the inclination direction of each of the second inclined surfaces 36 relative to the height direction X2 is indicated by the symbol θ2. The smaller angle θ1 out of the angles formed by the width direction X3 and the inclination direction of each of the first inclined surfaces 35 relative to the height direction X2 is the inclination angle of each of the first inclined surfaces 35 that widen in a tapered manner in the height direction X2 at the two end sides in the width direction X3 inside the guide portion 31. The smaller angle θ2 out of the angles formed by the width direction X3 and the inclination direction of each of the second inclined surfaces 36 relative to the height direction X2 is the inclination angle of each of the second inclined surfaces 36 that extend in a tapered manner toward the entrances of the insertion holes 34 between adjacent insertion holes 34. The angle θ1, which is the inclination angle of each of the first inclined surfaces 35, is set larger than the angle θ2, which is the inclination angle of each of the second inclined surfaces 36.

Also, as shown in FIGS. 21 to 23 and 25 to 28, the inner wall of the guide portion 31 is provided with third inclined surfaces 37 respectively on two end sides in the front-rear direction X4, which is a direction perpendicular to the width direction X3 and the height direction X2. The third inclined surfaces 37 are inclined relative to the height direction X2 so as to widen in a tapered manner while extending in the height direction X2 and outward in the front-rear direction X4 to the opening 33. The third inclined surfaces 37 are respectively provided at the two end sides of the inner wall of the guide portion 31 in the front-rear direction X4, and are respectively continuous with the two rows of insertion holes 34 among the insertion holes 34 arranged side by side in two rows in the width direction X3.

Also, as shown in FIGS. 21 to 23, 25, and 28, inside the guide portion 31, fourth inclined surfaces 53 are respectively provided between pairs of insertion holes 34 adjacent to each other in the front-rear direction X4. The fourth inclined surfaces 53 provided between insertion holes 34 adjacent in the front-rear direction X4 are surfaces inclined relative to the height direction X2 so as to extend in a tapered manner while extending in the insertion direction X1 and toward the openings of the insertion holes 34 into which the partner connection members 101a are inserted. The fourth inclined surfaces 53 are provided so as to be continuous with the insertion holes 34. Also, between each pair of insertion holes 34 adjacent in the front-rear direction X4, the fourth inclined surfaces 53 that are continuous with the adjacent insertion holes 34 are side by side in the front-rear direction X4.

As shown in FIGS. 25 and 28, the dimension in the front-rear direction X4 of the third inclined surfaces 37 provided at the two end sides of the inner wall of the guide portion 31 in the front-rear direction X4 is set larger than the dimension in the front-rear direction X4 of the fourth inclined surfaces 53 provided between insertion holes 34 adjacent in the front-rear direction X4. Note that in FIG. 28, a dimension Y3 of the third inclined surfaces 37 in the front-rear direction X4 is indicated by a double-headed arrow Y3, and a dimension Y4 of the fourth inclined surfaces 53 in the front-rear direction X4 is indicated by a double-headed arrow Y4. The dimension Y3 of the third inclined surfaces 37 in the front-rear direction X4 is set larger than the dimension Y4 of the fourth inclined surfaces 53 in the front-rear direction X4.

As shown in FIGS. 25 and 28, the dimension of the third inclined surfaces 37 in the height direction X2 is set larger than the dimension of the fourth inclined surfaces 53 in the height direction X2. Note that in FIG. 28, a dimension H3 of the third inclined surfaces 37 in the height direction X2 is indicated by a double-headed arrow H3, and a dimension H4 of the fourth inclined surfaces 53 in the height direction X2 is indicated by a double-headed arrow H4. The dimension H3 of the third inclined surfaces 37 in the height direction X2 is set larger than the dimension H4 of the fourth inclined surfaces 53 in the height direction X2.

Also, as shown in FIGS. 25 and 28, the magnitude of the smaller angle out of the angles formed by the front-rear direction X4 and the inclination direction of each of the third inclined surfaces 37 relative to the height direction X2 is set larger than the magnitude of the smaller angle out of the angles formed by the front-rear direction X4 and the inclination direction of each of the fourth inclined surfaces 53 relative to the height direction X2. Note that in FIG. 28, a smaller angle θ3 out of the angles formed by the front-rear direction X4 and the inclination direction of each of the third inclined surfaces 37 relative to the height direction X2 is indicated by the symbol θ3. Also, in FIG. 28, a smaller angle θ4 out of the angles formed by the front-rear direction X4 and the inclination direction of each of the fourth inclined surfaces 53 relative to the height direction X2 is indicated by the symbol θ4. The smaller angle θ3 out of the angles formed by the front-rear direction X4 and the inclination direction of each of the third inclined surfaces 37 relative to the height direction X2 is the inclination angle of each of the third inclined surfaces 37 that widen in a tapered manner in the height direction X2 at the two end sides in the front-rear direction X4 inside the guide portion 31. The smaller angle θ4 out of the angles formed by the front-rear direction X4 and the inclination direction of each of the fourth inclined surfaces 53 relative to the height direction X2 is the inclination angle of each of the fourth inclined surfaces 53 that extend in a tapered manner toward the entrances of the insertion holes 34 between insertion holes 34 adjacent in the front-rear direction X4. The angle θ3, which is the inclination angle of each of the third inclined surfaces 37, is set larger than the angle θ4, which is the inclination angle of each of the fourth inclined surfaces 53.

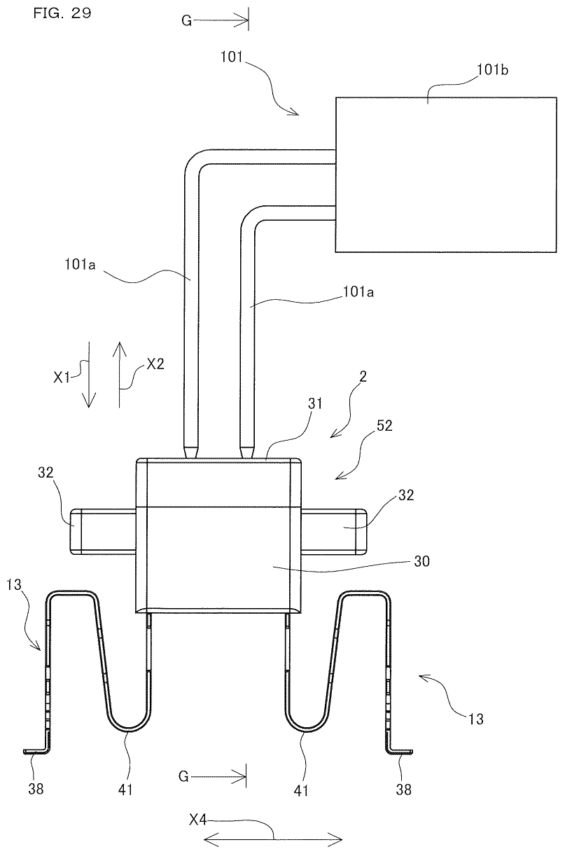

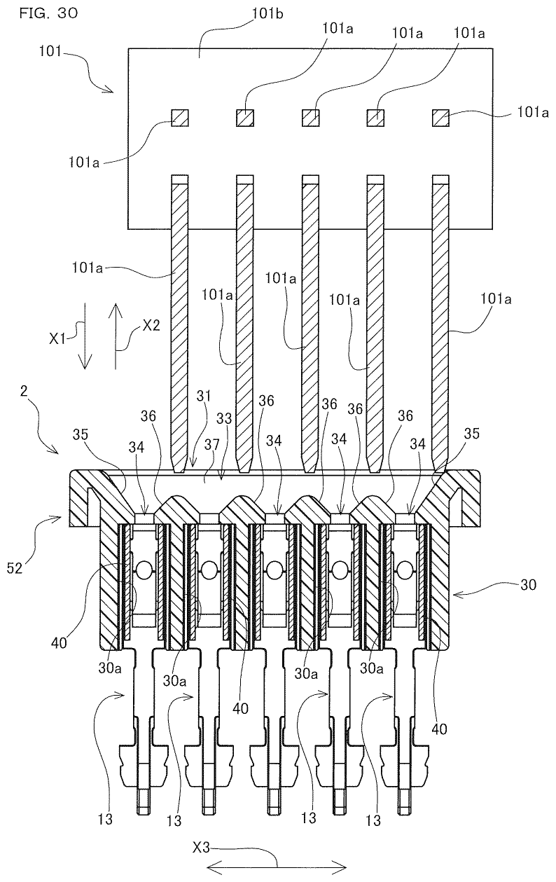

The following is a more detail description of operations when the pin-shaped partner connection members 101a arranged side by side in two rows in the partner connector 101 are inserted into and connected to the electrical connector 2. When inserting the partner connection members 101a into the electrical connector 2, the partner connection members 101a are inserted into the movable housing 52 of the electrical connector 2. At this time, there are cases where the partner connection members 101a are inserted into the movable housing 52 at deviated insertion positions. FIG. 29 is a side view illustrating a state immediately before the pin-shaped partner connection members 101a of the partner connector 101 are inserted into the electrical connector 2, with the fixed housing 51 being omitted from the electrical connector 2. FIG. 30 is a cross-sectional view taken along a line G-G in FIG. 29. FIGS. 29 and 30 show the case where the partner connection members 101a are inserted into the movable housing 52 at insertion positions deviated in the width direction X3.

As shown in FIGS. 29 and 30, when inserting the partner connection members 101a into the movable housing 52, the partner connection members 101a are inserted into the opening 33 of the guide portion 31 of the movable housing 52. In the case where the partner connection members 101a are inserted into the movable housing 52 at insertion positions deviated in the width direction X3, the partner connection members 101a are inserted into the opening 33 at positions deviated in the width direction X3 so as to not overlap the insertion holes 34 in the insertion direction X1. When the partner connection members 101a inserted into the opening 33 of the guide portion 31 are inserted into the opening 33 at insertion positions deviated in the width direction X3, the leading end portions of the partner connection members 101a at one of the two end sides in the width direction X3 among the partner connection members 101a arranged side by side in two rows come into contact with the first inclined surface 35 at the corresponding one of the two end sides in the width direction X3 of the inner wall of the guide portion 31. Note that the dimension H1 of the first inclined surfaces 35 in the height direction X2 is set larger than the dimension H2 of the second inclined surfaces 36 in the height direction X2, and furthermore, the dimension W1 of the first inclined surfaces 35 in the width direction X3 is set larger than the dimension W2 of the second inclined surfaces 36 in the width direction X3. Therefore, if the partner connection members 101a arranged side by side in two rows are inserted into the opening 33 of the guide portion 31 at positions deviated in the width direction X3, before the leading end portions of the partner connection members 101a come into contact with the second inclined surfaces 36 leading to the insertion holes 34, the leading end portions of the partner connection members 101a at one of the two end sides in the width direction X3 among the partner connection members 101a comes into contact with the first inclined surface 35 at the corresponding one of the two end sides in the width direction X3 of the inner wall of the guide portion 31.

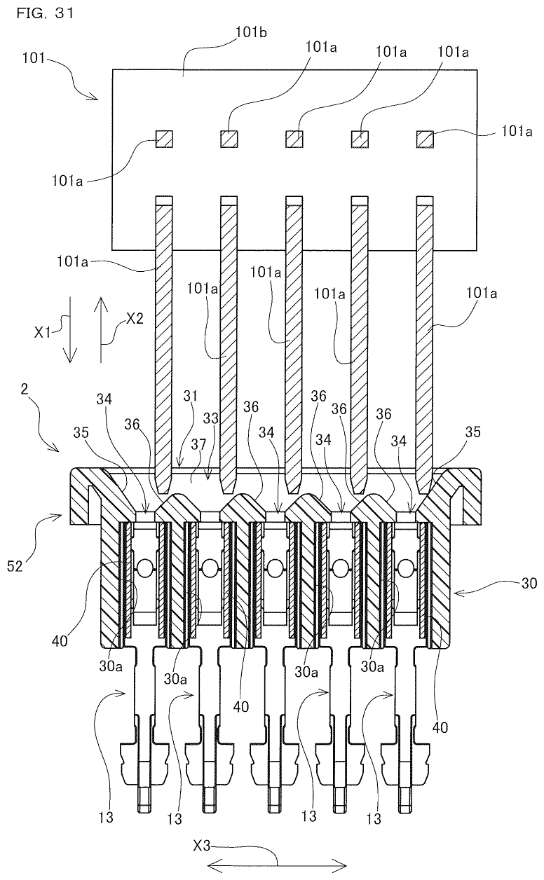

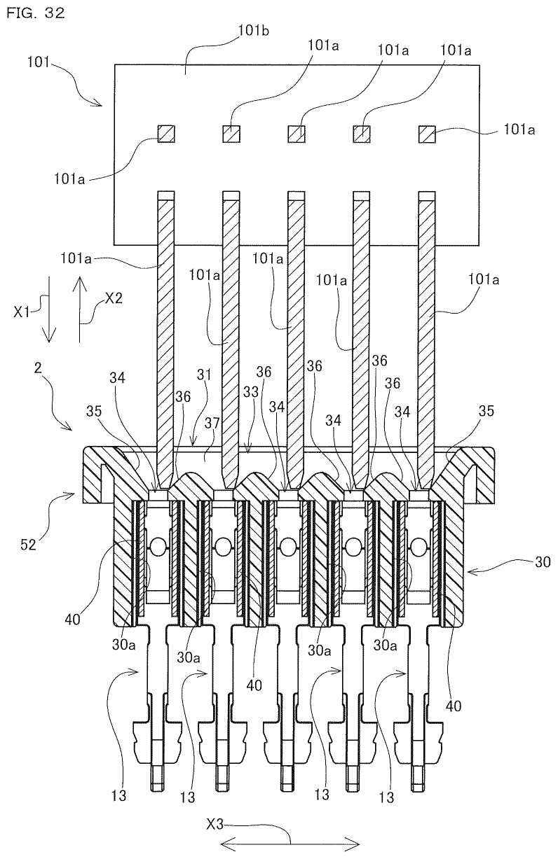

FIGS. 31 and 32 are cross-sectional views showing a state in which the pin-shaped partner connection members 101a of the partner connector 101 are being inserted into the electrical connector 2, the cross sections being taken at a position corresponding to the line G-G in FIG. 29. Note that FIG. 31 is a diagram showing a state in which the partner connection members 101a are inserted deeper into the guide portion 31 from the state shown in FIG. 30, and FIG. 32 is a diagram showing a state in which the partner connection members 101a are inserted even deeper into the guide portion 31 from the state shown in FIG. 31. As shown in FIG. 31, when the partner connection members 101a arranged side by side in two rows are inserted into the opening 33 and the partner connection members 101a at one of the two end sides in the width direction X3 come into contact with the corresponding first inclined surface 35, those partner connection members 101a at the one of the two end sides in the width direction X3 slide along the corresponding first inclined surface 35 while being inserted into the opening 33. Accordingly, the partner connection members 101a arranged side by side in two rows move in the insertion direction X1 together with the partner connection members 101a at the one of the two end sides in the width direction X3 that slide along the corresponding first inclined surface 35 while being inserted into the opening 33. Therefore, the partner connection members 101a arranged side by side in two rows are guided by the first inclined surface 35 while being inserted into the guide portion 31. As shown in FIG. 32, the partner connection members 101a are guided by the first inclined surface 35 while being inserted deeper into the guide portion 31, and are then guided to the corresponding insertion holes 34. Upon being guided to the insertion holes 34, the partner connection members 101a are then respectively inserted into the insertion holes 34. The partner connection members 101a inserted into the insertion holes 34 pass through the insertion holes 34, come into contact with the spring contact portions 40b of the partner connection portions 40 of the terminals 13 held inside the movable housing 12, and are electrically connected to the terminals 13.

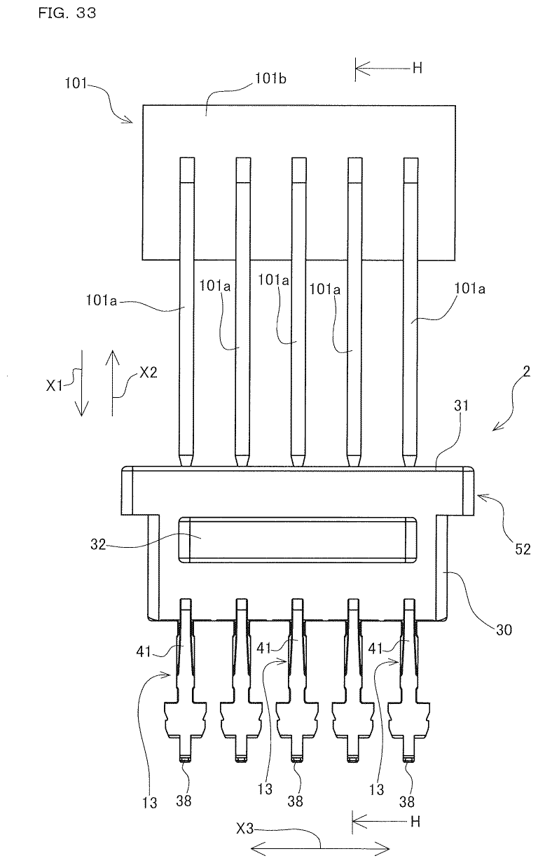

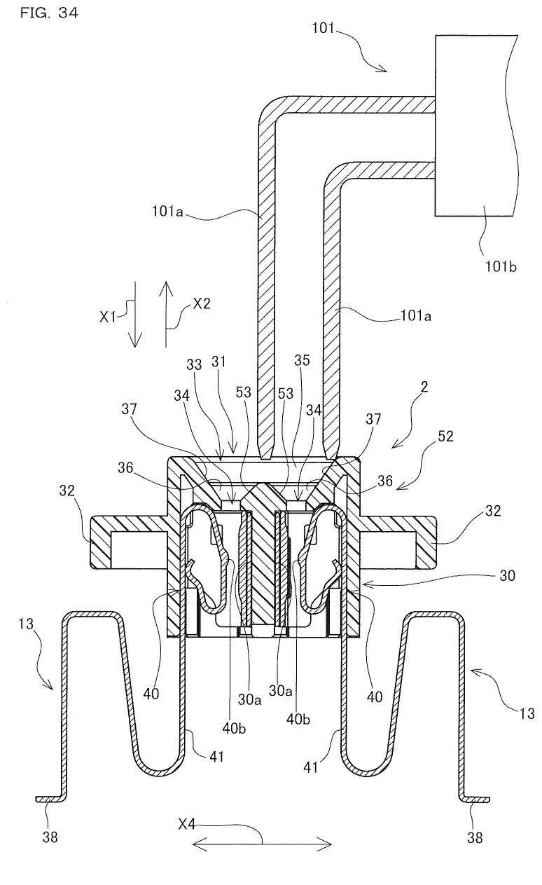

Next, a case will be described in which the partner connection members 101a arranged side by side in two rows are inserted into the movable housing 52 at insertion positions deviated in the front-rear direction X4. FIG. 33 is a front view illustrating a state immediately before the pin-shaped partner connection members 101a of the partner connector 101 are inserted into the electrical connector 2, with the fixed housing 51 being omitted from the electrical connector 2. FIG. 34 is a cross-sectional view taken along a line H-H in FIG. 33. FIGS. 33 and 34 show the case where the partner connection members 101a arranged side by side in two rows are inserted into the movable housing 52 at insertion positions deviated in the front-rear direction X4.

As shown in FIGS. 33 and 34, when inserting the partner connection members 101a into the movable housing 52, the partner connection members 101a are inserted into the opening 33 of the guide portion 31 of the movable housing 52. In the case where the partner connection members 101a are inserted into the movable housing 12 at insertion positions deviated in the front-rear direction X4, the partner connection members 101a are inserted into the opening 33 at positions deviated in the front-rear direction X4 so as to not overlap the insertion holes 34 in the insertion direction X1. When the partner connection members 101a inserted into the opening 33 of the guide portion 31 are inserted into the opening 33 at insertion positions deviated in the front-rear direction X4, the leading end portions of the partner connection members 101a arranged side by side in the row on one side in the front-rear direction X4, among the partner connection members 101a arranged side by side in two rows, come into contact with the third inclined surface 37 at one of the two end sides in the front-rear direction X4 of the inner wall the guide portion 31. Note that the dimension H3 of the third inclined surfaces 37 in the height direction X2 is set larger than the dimension H4 of the fourth inclined surfaces 53 in the height direction X2, and the dimension Y3 of the third inclined surfaces 37 in the front-rear direction X4 is set larger than the dimension Y4 of the fourth inclined surfaces 53 in the front-rear direction X4. Therefore, if the partner connection members 101a arranged side by side in two rows are inserted into the opening 33 of the guide portion 31 at positions deviated in the front-rear direction X4, before the leading end portions of the partner connection members 101a reach the same height as the fourth inclined surfaces 53 leading to the insertion holes 34, the leading end portions of the partner connection members 101a arranged side by side in the row on one side in the front-rear direction X4 come into contact with the third inclined surface 37 at one of the two end sides in the front-rear direction X4 of the inner wall the guide portion 31.

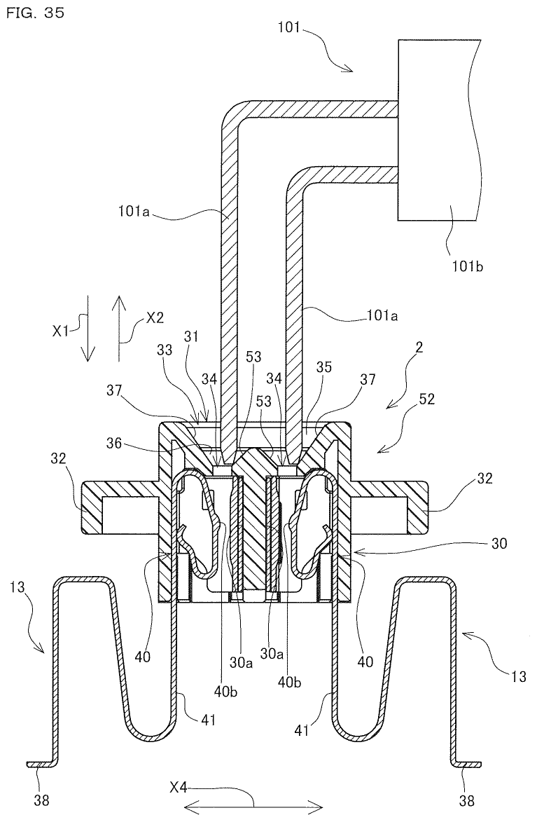

FIG. 35 is a cross-sectional view illustrating a state in which the pin-shaped partner connection members 101a of the partner connector 101 are being inserted into the electrical connector 2, the cross section being taken at a position corresponding to the line H-H in FIG. 33. As shown in FIG. 35, when the partner connection members 101a are inserted into the opening 33 and the partner connection members 101a arranged side by side in the row on one side in the front-rear direction X4, among the partner connection members 101a arranged side by in two rows, come into contact with the third inclined surface 37 at one of the two end sides in the front-rear direction X4, the partner connection members 101a arranged side by side in the row on the one side in the front-rear direction X4 slide along the corresponding third inclined surface 37 while being inserted into the opening 33. Accordingly, the partner connection members 101a arranged side by side in two rows move in the insertion direction X1 together with the partner connection members 101a that are arranged side by side in the row on the one side in the front-rear direction X4 and slide along the corresponding third inclined surface 37 while being inserted into the opening 33. Therefore, the partner connection members 101a arranged side by side in two rows are guided by the third inclined surface 37 while being inserted into the guide portion 31. Then, the partner connection members 101a are guided by the third inclined surface 37 while being inserted deeper into the guide portion 31, and are then guided to the corresponding insertion holes 34. Upon being guided to the insertion holes 34, the partner connection members 101a are then respectively inserted into the insertion holes 34. The partner connection members 101a inserted into the insertion holes 34 pass through the insertion holes 34, come into contact with the spring contact portions 40b of the partner connection portions 40 of the terminals 13 held inside the movable housing 52, and are electrically connected to the terminals 13.

According to the second embodiment described above, when connecting the pin-shaped partner connection members 101a arranged side by side in two rows to the electrical connector 2, the partner connection members 101a are inserted into the opening 33 of the guide portion 31 of the movable housing 52. If the partner connection members 101a inserted into the opening 33 of the guide portion 31 of the movable housing 52 are inserted into the opening 33 without deviation in the insertion positions, the partner connection members 101a are respectively inserted into the insertion holes 34 inside the guide portion 31. The partner connection members 101a inserted into the insertion holes 34 are respectively electrically connected to the terminals 13. However, if the partner connection members 101a inserted into the opening 33 of the guide portion 31 of the movable housing 52 are inserted into the opening 33 at insertion positions deviated in the width direction X3, the leading end portions of the partner connection members 101a at one of the two end sides in the width direction X3, among the partner connection members 101a arranged side by side in two rows, come into contact with the first inclined surface 35 at one of the two end sides in the width direction X3 of the inner wall of the guide portion 31. Note that the first inclined surfaces 35, which are inclined so as to extend in the height direction X2 and outward in the width direction X3 at the two end sides in the width direction X3 of the inner wall of the guide portion 31, have a larger dimension in the height direction X2 and dimension in the width direction X3 than the second inclined surfaces 36, which are inclined toward the entrances of the insertion holes 34 between insertion holes 34 adjacent in the width direction X3. Therefore, if the partner connection members 101a arranged side by side in two rows are inserted into the opening 33 of the guide portion 31 at positions deviated in the width direction X3, before the leading end portions of the partner connection members 101a come into contact with the second inclined surfaces 36 leading to the insertion holes 34, the leading end portions of the partner connection members 101a at one of the two end sides in the width direction X3 among the partner connection members 101a come into contact with the first inclined surface 35 at the corresponding one of the two end sides in the width direction X3 of the inner wall of the guide portion 31. Then, the partner connection members 101a at one of the two end sides in the width direction X3 slide along the corresponding first inclined surface 35 while being inserted into the opening 33. Accordingly, the partner connection members 101a arranged side by side in two rows move together with the partner connection members 101a at the one of the two end sides in the width direction X3 that slide along the corresponding first inclined surface 35 while being inserted into the opening 33, and are guided by the first inclined surface 35 while being inserted into the guide portion 31. The partner connection members 101a are guided along the inclination direction of the first inclined surface 35 while being inserted into the guide portion 31, and are then respectively inserted into the insertion holes 34. Therefore, even if the partner connection members 101a are inserted into the movable housing 52 at insertion positions deviated in the width direction X3, the partner connection members 101a are guided along the inclination direction of the first inclined surface 35 while being inserted into the guide portion 31, and are appropriately inserted into the insertion holes 34. Therefore, the operation for inserting the pin-shaped partner connection members 101a arranged side by side in two rows into the electrical connector 2 for connection thereto can be performed appropriately and easily. Also, according to the second embodiment, with a simple structure in which the movable housing 52 includes the first inclined surfaces 35 at the two end sides in the width direction X3 of the guide portion 31 provided with the opening 33, the operation for inserting the pin-shaped partner connection members 101a arranged side by side in two rows into the electrical connector 2 for connection thereto can be performed appropriately and easily. Therefore, it is possible to suppress an increase in the size and the complexity of the structures of the electrical connector 2 and the partner connector 101 connected to the electrical connector 2.

As described above, according to the second embodiment, it is possible to provide the electrical connector 2 that enables appropriately and easily performing the operation of inserting and connecting the pin-shaped partner connection members arranged side by side in two rows, and enables suppressing an increase in the size and the complexity of the structure.

Also, in the case where the magnitude of the smaller angle θ1 out of the angles formed by the width direction X3 and the inclination direction of each of the first inclined surfaces 35 relative to the height direction X2 is the same as the magnitude of the smaller angle θ2 out of the angles formed by the width direction X3 and the inclination direction of each of the second inclined surfaces 36 relative to the height direction X2, when the partner connection members 101a are inserted into the guide portion 31 while being guided along the inclination direction of one of the first inclined surfaces 35 and then reach the same height position as the second inclined surfaces 36, the partner connection members 101a are then guided along the one first inclined surface 35 and the second inclined surfaces 36 and respectively inserted into the insertion holes 34. In contrast, according to the second embodiment, the smaller angle θ1 out of the angles formed by the width direction X3 and the inclination direction of each of the first inclined surfaces 35 relative to the height direction X2 is set larger than the smaller angle θ2 out of the angles formed by the width direction X3 and the inclination direction of each of the second inclined surfaces 36 relative to the height direction X2. Accordingly, even when the partner connection members 101a are inserted into the guide portion 31 while being guided along the inclination direction of one of the first inclined surfaces 35 and then reach the same height position as the second inclined surfaces 36, the partner connection members 101a are then guided along the one first inclined surface 35 and respectively inserted into the insertion holes 34 substantially without sliding along the second inclined surfaces 36. In this way, the partner connection members 101a inserted into the opening 33 of the movable housing 52 are guided along one of the first inclined surfaces 35 and respectively inserted into the insertion holes 34 substantially without sliding along the second inclined surfaces 36. Therefore, the operation of appropriately inserting and connecting the pin-shaped partner connection members 101a arranged side by side in two rows can be performed even more smoothly and easily.

Also, according to the second embodiment, in the case where the pin-shaped partner connection members 101a arranged side by side in two rows are inserted into the opening 33 of the guide portion 31 of the movable housing 52 at insertion positions deviated in the front-rear direction X4, the leading end portions of the partner connection members 101a arranged side by side in the row on one side in the front-rear direction X4, among the partner connection members 101a arranged side by side in two rows, come into contact with the third inclined surface 37 at one of the two end sides in the front-rear direction X4 of the inner wall of the guide portion 31. Note that the third inclined surfaces 37, which are inclined so as to extend in the height direction X2 and outward in the front-rear direction X4 at the two end sides in the front-rear direction X4 of the inner wall of the guide portion 31, have a larger dimension in the height direction X2 and dimension in the front-rear direction X4 than the fourth inclined surfaces 53, which are inclined toward the entrances of the insertion holes 34 between insertion holes 34 adjacent in the front-rear direction X4. Therefore, if the partner connection members 101a arranged side by side in two rows are inserted into the opening 33 of the guide portion 31 at positions deviated in the front-rear direction X4, before the leading end portions of the partner connection members 101a reach the same height as the fourth inclined surfaces 53 leading to the insertion holes 34, the leading end portions of the partner connection members 101a arranged side by side in the row on one side in the front-rear direction X4 come into contact with the third inclined surface 37 at one of the two end sides in the front-rear direction X4 of the inner wall the guide portion 31. The partner connection members 101a then slide along the third inclined surface 37 while being inserted into the opening 33. As a result, the partner connection members 101a arranged side by side in two rows move together with the partner connection members 101a that are arranged side by side in the row on one side in the front-rear direction X4 and slide along the corresponding third inclined surface 37 while being inserted into the opening 33, and are guided by the third inclined surface 37 while being inserted into the guide portion 31. The partner connection members 101a are guided along the inclination direction of the third inclined surface 37 while being inserted into the guide portion 31, and are then respectively inserted into the insertion holes 34. Therefore, even if the partner connection members 101a are inserted into the movable housing 52 at insertion positions deviated in the front-rear direction X4, the partner connection members 101a are guided along the inclination direction of the third inclined surface 37 while being inserted into the guide portion 31, and are appropriately inserted into the insertion holes 34. Therefore, the operation for inserting the pin-shaped partner connection members 101a arranged side by side in two rows into the electrical connector 2 for connection thereto can be performed appropriately and easily.

Also, in the case where the magnitude of the smaller angle θ3 out of the angles formed by the front-rear direction X4 and the inclination direction of each of the third inclined surfaces 37 relative to the height direction X2 is the same as the magnitude of the smaller angle θ4 out of the angles formed by the front-rear direction X4 and the inclination direction of each of the fourth inclined surfaces 53 relative to the height direction X2, when the partner connection members 101a are guided along the inclination direction of one of the third inclined surfaces 37 while being inserted into the guide portion 31 and then reach the same height position as the fourth inclined surfaces 53, the partner connection members 101a are then guided along the one third inclined surface 37 and the fourth inclined surfaces 53 and respectively inserted into the insertion holes 34. In contrast, according to the second embodiment, the smaller angle θ3 out of the angles formed by the front-rear direction X4 and the inclination direction of each of the third inclined surfaces 37 relative to the height direction X2 is set larger than the smaller angle θ4 out of the angles formed by the front-rear direction X4 and the inclination direction of each of the fourth inclined surfaces 53 relative to the height direction X2. Accordingly, even when the partner connection members 101a are guided along the inclination direction of one of the third inclined surfaces 37 while being inserted into the guide portion 31 and then reach the same height position as the fourth inclined surfaces 53, the partner connection members 101a are then guided along the one third inclined surface 37 and respectively inserted into the insertion holes 34 substantially without sliding along the fourth inclined surfaces 53. In this way, the partner connection members 101a inserted into the opening 33 of the movable housing 52 are guided along the one third inclined surface 37 and respectively inserted into the insertion holes 34 substantially without sliding along the fourth inclined surfaces 53. Therefore, the operation of appropriately inserting and connecting the pin-shaped partner connection members 101a arranged side by side in two rows can be performed even more smoothly and easily.

### Variations

Although embodiments of the present invention have been described above, the present invention is not limited to the above-described embodiments, and various modifications can be made within the scope of the claims. In other words, the present invention is not limited to the embodiments described above, but rather the scope of the present invention is of course intended to include all variations, applications, and equivalents thereof encompassed in the scope of the appended claims as variations and applications that would become apparent by reading and understanding this specification. For example, modifications such as the following may be implemented.

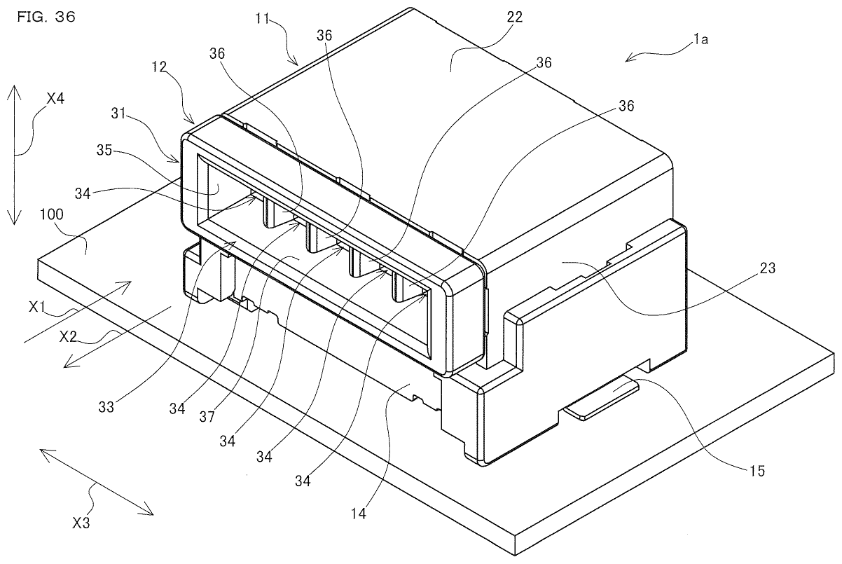

In the first embodiment described above, an example is described in which the insertion direction X1 and the height direction X2 of the electrical connector 1 are directions perpendicular to the surface of the substrate 100 that spreads in a flat manner when the electrical connector 1 is disposed on the substrate 100, but the present invention is not limited to this. A configuration is possible in which the insertion direction X1 and the height direction X2 of the electrical connector are parallel with the surface of the substrate 100 that spreads in a flat manner when the electrical connector is disposed on the substrate 100, and a variation such that as shown in FIGS. 36 to 39 may also be implemented, for example.

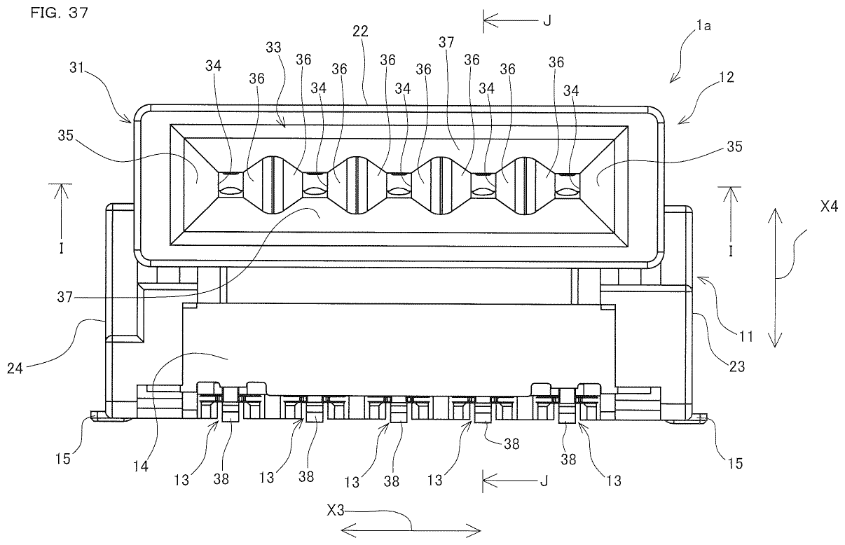

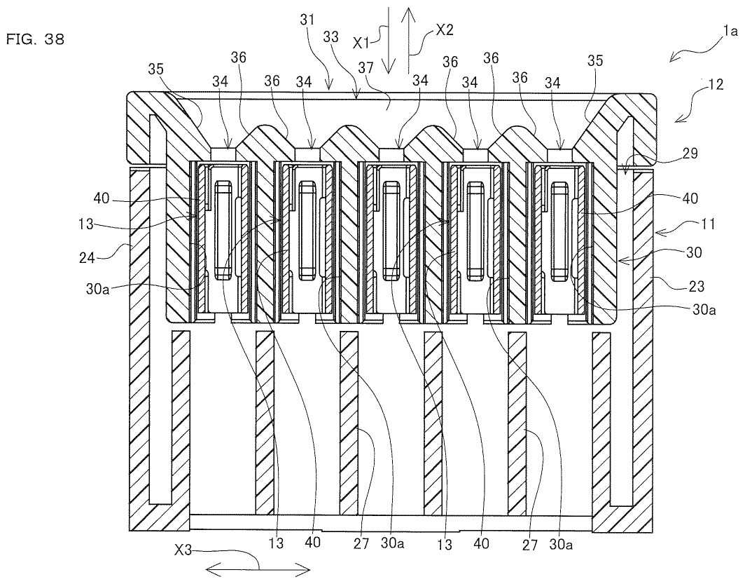

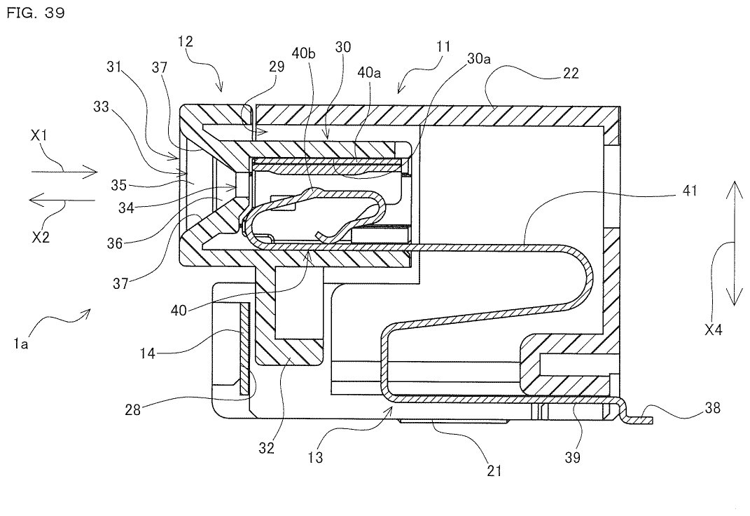

FIG. 36 is a perspective view of an electrical connector 1a according to a variation together with a substrate. FIG. 37 is a front view of the electrical connector 1a. FIG. 38 is a cross-sectional view taken along a line I-I in FIG. 37. FIG. 39 is a cross-sectional view taken along a line J-J in FIG. 37. Note that in the description of the following variation, elements having configurations similar to those in the first embodiment described above and elements having configurations corresponding to those in the first embodiment are denoted by the same reference numerals in the drawings referred to by the same reference numerals in order to omit redundant descriptions.

The electrical connector 1a according to the variation shown in FIGS. 36 to 39 has a configuration in which the insertion direction X1, which is the direction in which the partner connection members 101a are inserted into the guide portion 31 of the movable housing 12, and the height direction X2, which is the direction opposite to the insertion direction X1, are parallel with the surface of the substrate 100 that spreads in a flat manner when the electrical connector 1a is disposed on the substrate 100. Also, in the electrical connector 1a, the front-rear direction X4, which is a direction perpendicular to both the height direction X2 and the width direction X3, which is the arrangement direction of the insertion holes 34, is perpendicular to the surface of the substrate 100 that spreads in a flat manner.

As in the variation shown in FIGS. 36 to 39, a configuration is possible in which the insertion direction X1 and the height direction X2 of the electrical connector 1a are parallel with the surface of the substrate 100 that spreads in a flat manner when the electrical connector 1a is disposed on the substrate 100.

### INDUSTRIAL APPLICABILITY

The present invention is broadly applicable as an electrical connector to which a plurality of pin-shaped partner connection members arranged side by side are connected by being inserted into the electrical connector, the electrical connector including a fixed housing to be disposed on a substrate, a movable housing mounted so as to be displaceable relative to the fixed housing, and a plurality of terminals that support the movable housing so as to be displaceable relative to the fixed housing.

### DESCRIPTION OF REFERENCE SIGNS

1, 1a, 2 Electrical connector
11, 51 Fixed housing
12, 52 Movable housing
13 Terminal
31 Guide portion
33 Opening
34 Insertion hole
35 First inclined surface
36 Second inclined surface
37 Third inclined surface
53 Fourth inclined surface
100 Substrate
101a Partner connection member

What is claimed is:

1. An electrical connector to which a plurality of pin-shaped partner connection members arranged side by side are connected by being inserted into the electrical connector, the electrical connector comprising:
a fixed housing configured to be disposed on a substrate;
a movable housing configured to be mounted so as to be displaceable relative to the fixed housing; and
a plurality of terminals configured to support the movable housing so as to be displaceable relative to the fixed housing, and configured to be electrically connected to the plurality of partner connection members,
wherein the movable housing is provided with:
a guide portion provided with an opening into which the plurality of partner connection members are inserted, and configured to guide the plurality of partner connection members from the opening into the movable housing; and
a plurality of insertion holes arranged side by side inside the guide portion and configured to respectively receive insertion of the plurality of partner connection members guided by the guide portion,
an inner wall of the guide portion is provided with first inclined surfaces respectively at two end sides in a width direction corresponding to a direction in which the plurality of insertion holes are arranged side by side, the first inclined surfaces being inclined relative to a height direction, which is a direction opposite to an insertion direction in which the plurality of partner connection members are inserted into the guide portion, so as to widen in a tapered manner while extending in the height direction and outward in the width direction to the opening,
second inclined surfaces are provided between each pair of the insertion holes adjacent to each other in the width direction, the second inclined surfaces being inclined relative to the height direction so as to extend in a tapered manner while extending in the insertion direction and toward entrances of the insertion holes into which the plurality of partner connection members are inserted,
a dimension of the first inclined surfaces in the width direction is larger than a dimension of the second inclined surfaces in the width direction, and
a dimension of the first inclined surfaces in the height direction is larger than a dimension of the second inclined surfaces in the height direction.

2. The electrical connector according to claim 1,
wherein a magnitude of a smaller angle out of angles formed by the width direction and an inclination direction of each of the first inclined surfaces relative to the height direction is larger than a magnitude of a smaller angle out of angles formed by the width direction and an inclination direction of each of the second inclined surfaces relative to the height direction.

3. The electrical connector according to claim 1,
wherein the inner wall of the guide portion is provided with third inclined surfaces respectively at two end sides in a front-rear direction perpendicular to both the width direction and the height direction, the third inclined surfaces being inclined relative to the height direction so as to widen in a tapered manner while extending in the height direction and outward in the front-rear direction to the opening, and
a dimension of the third inclined surfaces in the height direction is larger than the dimension of the second inclined surfaces in the height direction.

4. An electrical connector to which a plurality of pin-shaped partner connection members arranged side by side in two rows are connected by being inserted into the electrical connector, the electrical connector comprising:
a fixed housing configured to be disposed on a substrate;
a movable housing configured to be mounted so as to be displaceable relative to the fixed housing; and
a plurality of terminals configured to support the movable housing so as to be displaceable relative to the fixed housing, and configured to be electrically connected to the plurality of partner connection members,
wherein the movable housing is provided with:
a guide portion provided with an opening into which the plurality of partner connection members are inserted, and configured to guide the plurality of partner connection members from the opening into the movable housing; and
a plurality of insertion holes arranged side by side in two rows inside the guide portion and configured to respectively receive insertion of the plurality of partner connection members guided by the guide portion,
an inner wall of the guide portion is provided with first inclined surfaces respectively at two end sides in a width direction corresponding to a direction in which the plurality of insertion holes are arranged side by side in two rows, the first inclined surfaces being inclined relative to a height direction, which is a direction opposite to an insertion direction in which the plurality of partner connection members are inserted into the guide portion, so as to widen in a tapered manner while extending in the height direction and outward in the width direction to the opening,
second inclined surfaces are provided between each pair of the insertion holes adjacent to each other in the width direction, the second inclined surfaces being inclined relative to the height direction so as to extend in a tapered manner while extending in the insertion direction and toward entrances of the insertion holes into which the plurality of partner connection members are inserted,
a dimension of the first inclined surfaces in the width direction is larger than a dimension of the second inclined surfaces in the width direction, and
a dimension of the first inclined surfaces in the height direction is larger than a dimension of the second inclined surfaces in the height direction.

5. The electrical connector according to claim 4,
wherein a magnitude of a smaller angle out of angles formed by the width direction and an inclination direction of each of the first inclined surfaces relative to the height direction is larger than a magnitude of a smaller angle out of angles formed by the width direction and an inclination direction of each of the second inclined surfaces relative to the height direction.

6. The electrical connector according to claim 4,
wherein the inner wall of the guide portion is provided with third inclined surfaces respectively at two end sides in a front-rear direction perpendicular to both the width direction and the height direction, the third inclined surfaces being inclined relative to the height direction so as to widen in a tapered manner while extending in the height direction and outward in the front-rear direction to the opening,
fourth inclined surfaces are provided between each pair of the insertion holes adjacent to each other in the front-rear direction, the fourth inclined surfaces being inclined relative to the height direction so as to extend in a tapered manner while extending in the insertion direction and toward the entrances of the insertion holes,
a dimension of the third inclined surfaces in the front-rear direction is larger than a dimension of the fourth inclined surfaces in the front-rear direction, and
a dimension of the third inclined surfaces in the height direction is larger than the dimension of the fourth inclined surfaces in the height direction.

7. The electrical connector according to claim 6,
wherein a magnitude of a smaller angle out of angles formed by the front-rear direction and an inclination direction of each of the third inclined surfaces relative to the height direction is larger than a magnitude of a smaller angle out of angles formed by the front-rear direction and an inclination direction of each of the fourth inclined surfaces relative to the height direction.
